(19) United States
(12) Patent Application Publication
(10) Pub. No.: US 2006/0237242 A1
(43) Pub. Date: Oct. 26, 2006

(54) Lightweight surface vehicle

(76) Inventor: Robert J. Burke, Santa Cruz, CA (US)

Correspondence Address: GLENN PATENT GROUP, 3475 EDISON WAY, SUITE L, MENLO PARK, CA, 94025, US

(21) Appl. No.: 11/346,081

(22) Filed: Feb. 1, 2006

Related U.S. Application Data
(63) Continuation-in-part of application No. 10/381,757, filed on Mar. 25, 2003, now Pat. No. 7,017,690.
(60) Provisional application No. 60/235,239, filed on Sep. 25, 2000.

(51) Int. Cl. B62D 59/04; B62D 61/10; B60K 6/00; B60K 17/00

(52) U.S. Cl. 180/23; 180/65.2; 180/14.2; 280/124.128; 180/357

(57) ABSTRACT

Lightweight wheeled surface vehicles of various types and sizes constructed chiefly from commercial off-the-shelf (COTS) parts, incorporate alternate suspensions, e.g. swingarms. One embodiment provides a vehicle incorporating a cellular body design wherein the vehicle is constructed from a varying number of substantially identical cells, assembled end-to-end to produce vehicles of varying size and capacity. Additional embodiments include lightweight passenger vehicles, such as automobiles, manufacturable from COTS parts, including independent suspensions providing large vertical wheel travel. One embodiment provides an automobile-type vehicle having a roll-cage frame, and a lightweight, exo-skeleton external frame, provided in multiple wheel configurations, e.g. three- or four-wheeled configurations. Body panels are quickly and easily attached to the tubular frame and also easily removed and switched and readily replaceable. Bicycles are equipped with electric pedal assist units. Additionally, a pneumatic pedal assist reduces peak power requirements and prolongs battery life.

### CROSS-REFERENCE TO RELATED APPLICATION

This application is a continuation-in-part of U.S. patent application Ser. No. 10/381,757 filed Mar. 25, 2003, which claims priority from PCT Application No. PCT/US01/29809, filed Sep. 24, 2001, having a priority date of Sep. 25, 2000, both of which are incorporated as if fully set forth herein by this reference thereto.

### BACKGROUND OF THE INVENTION

1. Field of the Invention

In general, the invention relates to the field of wheeled transportation. More particularly, the invention relates to lightweight, low-cost surface vehicles.

2. State of the Art

The population continues to increase, and at the same time, there is a continuing shift of population from small towns to major urban centers, exacerbating the highway congestion and urban sprawl that have characterized many large American cities since the mid-twentieth century. There is a growing belief that the favored mode of transportation, individually owned automobiles, imposes unacceptable environmental burdens and adversely affects quality of life. As a result of these forces, effective modes of urban mass transit have acquired a new priority. A sure sign of the new emphasis on providing effective vehicles and systems for urban mass transit is the rapidly increasing demand for urban transit buses. In just the United States, the current capital stock comprises at least fifty-five thousand separate vehicles; and the dollar value of annual purchases of new buses is well in excess of one billion dollars. The number of new units purchased is increasing at a rate of approximately ten to fifteen per cent per year. While much of the increased demand has come from the public sector, the demand for efficient, cost-effective buses is increasing in private sector activities as well; for example, point-to-point shuttling, tourism, education, inter-city transit and recreation.

Along with the increased demand for buses, there are also emerging increased expectations, especially from public sector purchasers and regulators, of the vehicles themselves, leading to a demand for bus designs that reduce public sector costs related to roadway maintenance and repair, street and highway expansion and parking; while also ameliorating social costs related to noise pollution, air pollution, long commute times, while providing increased handicapped accessibility.

Even in the face of substantial government subsidies for development of new bus technologies, significant changes to conventional bus technology have been slow in coming. By and large, efforts to integrate new materials and power alternatives have been insufficient to address changing expectations of urban transportation managers and passengers, or to significantly reduce operating costs and initial purchase costs. However, dwindling petroleum reserves and an increasing concern about the greenhouse effect are creating a new sense of urgency. The prior art reveals many attempts to improve manufacturability of buses, decrease curb weight, increase maneuverability and safety, increase passenger comfort, and improve fuel efficiency.

Thus, several urban transit vehicles that employ modular construction techniques are described. For example, V. Belik, B. Kurach, Y. Trach, Module element of city bus or like vehicle and bus assembled on the basis of such module elements, U.S. Pat. No. 4,469,369 (Sep. 4, 1984) describe a module element for a city bus that is itself fabricated from a chassis unit, a door section, and a window section. The modules may be left-handed or right-handed. Different versions of the chassis unit are provided according to whether it is to function as a drive unit or a steering unit. Modules are assembled with front and rear elements and varying numbers of center sections to provide buses of varying size and capacity.

H. Förster, Universal vehicle system for the public local traffic, U.S. Pat. No. 4,596,192 (Jun. 24, 1986) describes a vehicle system for local public passenger transportation in which differing vehicle components are assembled to create vehicles of different size and capacity. Vehicles usable only on tracks, ones for use with or without tracks and ones for use only without tracks are possible.

L. Bergström, H. Eklund, J. Pettersson, Chassis for a bus, PCT Application No. SE94/01108 (Nov. 24, 1993) describe a bus chassis in which different versions of a front-end module are readily created by combining different front wheel modules and driver's compartment modules so that the height of the driver's compartment in relation to the rest of the bus varies.

However, none of the examples above contemplate the use of unconventional suspension systems to enhance ride quality and reduce load requirements, permitting the use of composite building materials and lightweight parts. Nor do they consider improving vehicle mobility and maneuverability through the provision of features such as all-wheel drive and all wheel-steering, or alternate power strategies such as hybrid power systems, or microprocessor control of the various vehicle subsystems.

D. Quattrini, A. Carlo, Electrically powered urban public transport vehicle with a floor at a reduced height, European Patent Application No. 90202043 (Aug. 11, 1989) describes an urban mass transit vehicle having a passenger compartment at a reduced height above the ground, with the wheels being located near the front and end regions. Each axle is provided with its own drive motor, providing all-wheel drive, allowing for optimal traction under adverse weather and road conditions. Additionally, all wheel steering is included to enhance maneuverability in confined spaces. Quadratttini, et al., don't however envisage the use of hybrid power systems, or unconventional suspensions that allow reduction of load requirements, permitting construction of a vehicle with composite materials, and lightweight off-the shelf parts. Moreover, they do not think of cellular body construction.

Municipality of Rotterdam, Manufacturing and implementation of a lightweight hybrid bus, www.eltis.org/data/101e.htm, describes a bus incorporating a modular light body system that allows identical building systems for different sized vehicles, a substantial weight reduction, and hybrid traction. There is no mention of what features in the construction are responsible for the weight reduction, nor are features such as all-wheel drive, all-wheel steering, improved suspension systems, or microprocessor control of vehicle subsystems considered.

L. Woods, J. Hamilton, Computer optimized adaptive suspension system having combined shock absorber/air spring unit, U.S. Pat. No. 4,468,739 (Aug. 28, 1984) and L. Woods, J. Hamilton, Computer optimized adaptive suspension system, U.S. Pat. No. 4,634,142 (Jan. 6, 1987) describe a vehicle suspension system in which a computer controls damping and spring forces to optimize ride and handling characteristics under a wide range of driving conditions. While a variety of suspension characteristics are achievable by programming the controller, there is no evidence that the suspension system described incorporates features that reduce load bearing requirements for the vehicle frame, allowing the vehicle to be manufactured from lightweight, off-the-shelf automobile or light truck parts. Furthermore, the described suspension provides no means of adjusting vehicle height relative to the roadway. And there is no suggestion that the suspension is appropriate for use in urban mass transit vehicles.

P. Eisen, All-wheel steering for motor vehicles, U.S. Pat. No. 5,137,292 (Aug. 11, 1992) describes an all-wheel steering arrangement having a coupler mechanism between the front and rear axles. There is no indication that the described arrangement is suitable for anything other than vehicles having two axles. What's more, the steering system is a simple, mechanical system. There is no provision for individual control of each axle a microprocessor or controller in a multi-axle vehicle.

There exists, therefore a need for an urban transit vehicle that:
is affordable and easily manufactured;
is lightweight;
is highly maneuverable;
provides exceptional passenger comfort;
is energy-efficient; and
minimizes or eliminates air and noise pollution commonly associated with buses.

It would be a significant technological advance to provide a cellular body construction, in which vehicles are constructed from identical components or cells, one cell including a passenger compartment, the associated floor, sidewalls, roof, an axle with drive train, wheels, suspension, steering and brakes. It would be advantageous to construct vehicles of varying size, simply by “bolting together” the required number of cells, easily allowing the manufacture of vehicles having any number of evenly spaced axles. It would be desirable to provide a suspension system in which each wheel has its own independent suspension, thereby providing greatly improved ride quality. It would be an advantage to configure the suspension system to permit reduced load carrying requirements on the vehicle frame, allowing the vehicle to be fabricated from lightweight, off-the-shelf parts and lightweight materials. It would be a great benefit to equip the vehicle with an energy-efficient, hybrid fuel system, so that reliance on increasingly scarce and environmentally unfriendly fossil fuels is greatly reduced or eliminated. It would also be desirable to equip the vehicle with all-wheel steering, thus permitting a much-reduced steering radius and allowing the vehicle to be easily maneuvered in city traffic as well as on narrow, residential streets. It would be advantageous to provide an advanced control system that integrated control of the steering, suspension, braking and power systems.

### SUMMARY OF THE INVENTION

In recognition of such needs, the invention provides a lightweight, highly maneuverable surface vehicle incorporating a cellular body design in which the vehicle is constructed from a varying number of substantially identical cells, fixedly assembled end-to-end to produce vehicles of varying size and capacity. Each cell includes the passenger compartment, an associated section of floor, sidewalls, roof; an axle with drive train, wheels, suspension, steering and brakes. The body portion of the cells is fabricated from durable, lightweight materials such as composites or advanced steel products, greatly reducing the weight of the finished vehicle, which allows substantially increased fuel economy, and greatly reduced wear and tear on roadways. The invented vehicle has a multi-axle configuration, each cell having an axle, so that a typical vehicle has at least three axles preferably evenly spaced. A multi-axle suspension system provides independent suspensions that couple wheels at each end of each axle.

Providing multiple pairs of suspensions, for example, swingarm extensions, preferably closely and evenly spaced, reduces the load requirements for the body, allowing the use of lightweight stock parts, such as those for light trucks and SUV's, thus reducing further the necessary weight of the vehicle and substantially reducing manufacturing and repair costs.

An all-wheel steering system provides the vehicle exceptional maneuverability, also allowing the vehicle to be maneuvered in ways previously unavailable such as crab mode, for parking in tight spots, or pivot mode. Along with the suspension, power and braking systems, control of the steering system is mediated through a microprocessor-based command and control system.

A hybrid power system combines an alternative fueled engine to power electricity generation and all-wheel drive with main energy stored in a number of storage batteries.

Other embodiments of the invention provide surface vehicles of various types and sizes constructed chiefly from commercial off-the-shelf parts that incorporate an alternate type of independent suspension, a swingarm suspension, for example. One embodiment provides a transit vehicle incorporating a cellular body design in which the vehicle is constructed from a varying number of substantially identical cells, assembled end-to-end to produce vehicles of varying size and capacity. Each cell includes the passenger compartment, an associated section of floor, sidewalls, roof; an axle with drive train, wheels, suspension, steering and brakes.

Additional embodiments of the invention include lightweight passenger vehicles, such as automobiles, also manufacturable from commercial, off-the-shelf parts, including independent suspension such as swingarm suspensions. One embodiment provides an automobile-type vehicle having a roll-cage type frame, and a lightweight exo-skeleton type external frame. The present embodiment is provided in a variety of wheel configurations, for example three- or four-wheeled configurations. Body panels are quickly and easily attached to the tubular frame and also easily removed and switched and readily replaceable.

### BRIEF DESCRIPTION OF THE DRAWINGS

FIG. 1 shows an urban mass transit vehicle provided in a variety of sizes according to the invention;

FIG. 2 is an exploded view of an urban mass transit vehicle as in FIG. 1, constructed from a plurality of cells according to the invention;

FIG. 3 is a skeletal view of the body of an urban mass transit vehicle as in FIG. 1, showing the body frame according to the invention;

FIG. 4 shows the vehicle body of FIG. 3 equipped with passenger seating and a sunroof according to the invention;

FIG. 5 shows the manner of assembling vehicles of different sizes by combining different numbers of identical body cells according to the invention;

FIG. 6 illustrates the beneficial effects on ride quality achieved by providing independent, computer controlled suspensions on a rigid, multi-axle urban mass transit vehicle as shown in FIG. 1 according to the invention;

FIG. 7 provides a schematic view of an individual suspension and associated parts for one wheel according to the invention;

FIG. 8 provides a schematic view of a vehicle structure incorporating independent suspensions according to the invention;

FIG. 9 is a side elevation showing the integration of the suspension of FIG. 8 into an overall vehicle structure according to the invention;

FIG. 10 illustrates a height adjuster from the suspension of FIG. 7 according to the invention;

FIG. 11 illustrates a rapid-response, variable stiffness air spring from the suspension of FIG. 7 according to the invention;

FIG. 12 illustrates a drop-stop active shock absorber from the suspension of FIG. 7 according to the invention;

FIG. 13 provides plan views of an urban mass transit vehicle equipped with all-wheel steering in crab, pivot and track modes, respectively, according to the invention;

FIG. 14 provides a side elevation a vehicle incorporating an all-wheel steering system, according to the invention;

FIG. 15 illustrates a steering control interface for a vehicle as shown in FIG. 14 according to the invention;

FIG. 16 provides a schematic view of a control transducer from the steering system of FIG. 14 according to the invention;

FIG. 17 provides a schematic diagram illustrating coupling of the operator interface to the steering control transducer according to the invention;

FIG. 18 illustrates an axle with attached steering actuator mounted in a wheel well according to the invention;

FIG. 19 illustrates a power plant for an urban mass transit vehicle as shown in FIG. 1, according to the invention;

FIG. 20 shows a battery pack for an urban mass transit vehicle as shown in FIG. 1, according to the invention;

FIG. 21 illustrates a plurality of urban mass transit vehicles coupled end-to-end to form a train according to the invention;

FIG. 22 illustrates a transit vehicle as in FIGS. 10-6 provided with swingarm suspensions;

FIG. 23 illustrates a trailing arm suspension as in the vehicle of FIG. 22 according to the invention;

FIG. 24 provides a diagram of the forces and moments involved in a swingarm suspension;

FIG. 25 provides a diagram wherein the three main vertical positions of the suspension of FIG. 23 are superimposed upon each other;

FIG. 26 provides a diagram showing the three main vertical positions of the suspension of FIG. 23 separated from each other;

FIG. 27 provides a diagram illustrating an inline suspension that is steerable and capapble of large vertical wheel travel;

FIG. 28 illustrates a lightweight surface vehicle, according to the invention;

FIG. 29 illustrates an internal roll age frame from the vehicle of FIG. 28 according to the invention;

FIG. 30 provides a side, section view of the vehicle of FIG. 28, showing attachment of suspensions and wheels according to the invention

FIG. 31 illustrates a section view of a bulkhead form the vehicle frame of FIG. 30 according to the invention;

FIG. 32 illustrates a top plan view of the vehicle of FIG. 30 according to the invention;

FIG. 33 illustrates a rear elevation of the bulkhead of FIG. 31 according to the invention;

FIGS. 34-39 illustrate attachments of various body parts, doors and windows to a frame as in FIG. 28 according to the invention;

FIG. 40 illustrates side section views comparing four-wheeled and three wheeled embodiments of a vehicle as in FIG. 29 according to the invention;

FIG. 41 illustrates a single-seat electronic tricycle according to the invention;

FIG. 42 illustrates a bicycle equipped with a pneumatic pedal assist unit according to the invention;

FIG. 43 illustrates a second embodiment of an pneumatic pedal assist unit according to the invention;

FIG. 44 illustrates a bicycle chassis equipped with an electric wheel motor and a pneumatic pedal assist unit according to the invention.

### DETAILED DESCRIPTION

The current state of metropolitan transportation is problematic. As populations continue to grow, automobile transportation becomes increasingly difficult to sustain. The cost of building and maintaining highways, coupled with other problems such as long commute times, air pollution and dwindling petroleum reserves renders public transportation increasingly attractive. Unfortunately, because of land use decisions based on automobile transportation and its accompanying economics—typified by low-density suburban residential development, diffuse low-rise commercial development, and scattered development not easily accommodated in public transportation planning—effective solutions have been difficult to identify. Partly because of social factors such as a disinclination to use public transportation and problems with the medium itself, buses and related transit systems have not significantly increased the portion of the population using public transportation.

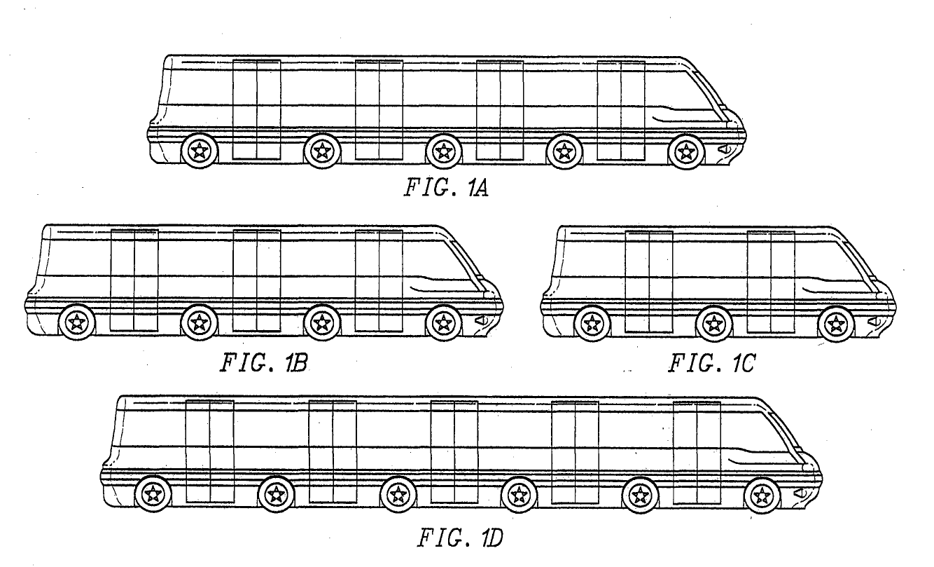

The invention provides a solution that radically changes both the economics of bus transportation and addresses many of the social factors that limit it. Referring now to FIGS. 1a-d, an urban mass transit vehicle is shown that incorporates a number of advantageous features:
Cellular body construction allowing vehicles of various sizes and capacities to be built using identical parts. Drive motors, suspensions, control systems engines and generators, virtually every component, are the same for small buses and large, reducing part inventories, mechanic and operator training and repair time.
Multiple independent suspensions reduce the load-carrying requirements of the frame so that the overall weight of the vehicle may be reduced; also reducing load requirements of each suspension, permitting the vehicle to be fabricated from off-the-shelf auto or light truck parts; and greatly stabilizing handling characteristics of the vehicle.
Computer control of braking and suspension systems, permitting limousine-quality ride without the porpoising and swaying of traditional buses.
Hybrid power system that combines an alternative-fueled engine for electricity generation and all-wheel electric drive with main energy storage in advanced chemical batteries and regenerative braking to recover kinetic energy. Along with the substantial reduction in weight, the power system significantly improves fuel economy, also eliminating the need for a bulky transmission, and providing improved driving characteristics.
Construction from lightweight materials, providing low maintenance and long vehicle life, and permitting use of advanced load-bearing designs and lower-cost fabrication techniques. Materials may be composite, or they may be advanced, lightweight metal products.
Weight/capacity advances, permitting vehicle configurations that improve payload to empty vehicle weight ratio of a 40-50 person bus from approximately 60% to approximately 150% at maximum payload, and providing extraordinary fuel efficiency.
Computer-mediated all-wheel steering, permitting much reduced turning radius, as well as “crab” and “pivot” turning.
Flexible seating configurations, allowing operators to increase or decrease the passenger seating capacity and configuration readily.
Multiple doors with option for compartmented interiors, offering a European train compartment feel and rapid entry, seating and exit.
Low floor with multiple door ingress/egress with curb-level walk-on access that exceeds ADA standards.
Automobile quality interiors with options.

As FIG. 1 shows, vehicles of different sizes and capacities are provided. FIG. 1a shows a vehicle having five axles; 1b, a four-axle vehicle; 1c a three-axle vehicle and finally, a vehicle having six axles is shown in FIG. 1d. As mentioned above, the body of the vehicle is fabricated, at least in part, from composite materials, such as fiberglass, graphite/epoxy or metal matrix composites. By replacing conventional materials with lightweight alternatives, such as composites and advanced metal products, it is possible to save weight and energy, reduce part count and assembly cost and to meet structural requirements that cannot be fulfilled using conventional materials.

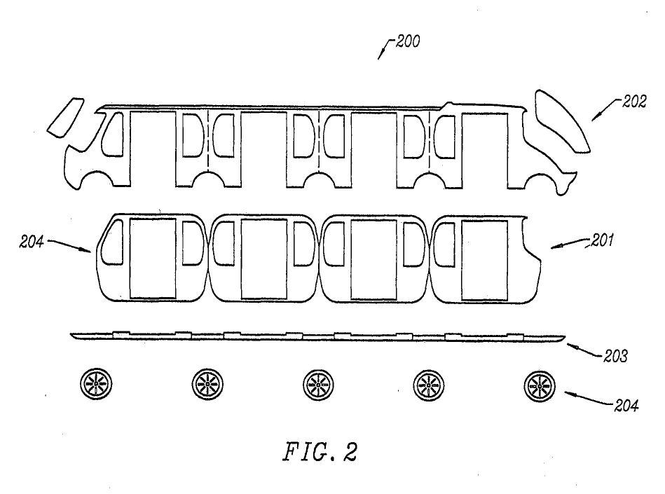

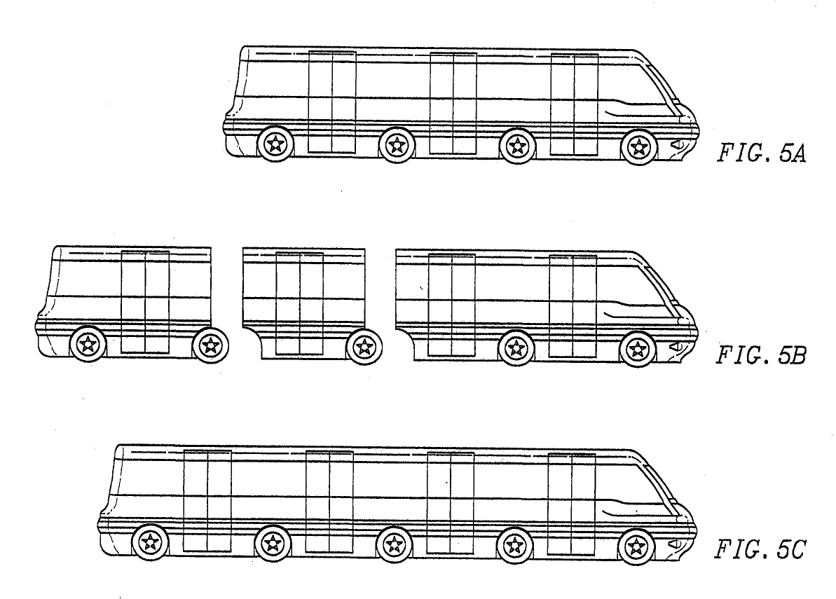

FIG. 2 provides an exploded view of the invention that illustrates the construction of the vehicle from substantially identical cells. A central feature of the invention is the composition of a bus of a given length from a specific number of cells. Accordingly, four compartments 201 are provided, corresponding to four cells. As shown, the end compartments are modified to provide front and end units. Four exterior units 202 are shown, and four floor sections 203. Five axles 204 with wheels coupled at each end are shown. Thus, one cell has two axles, while all remaining cells have one. In general, the end cell 204 is equipped with two axles, although the front cell could just as easily have two axles. For purposes of illustration, the various components of a cell have been shown separately. However, in actual practice, one cell includes a compartment, the associated section of floor, sidewalls, roof; one axle with drive train, wheels, suspension, steering and brake assemblies, all pre-assembled to form a single unit. Construction of a vehicle essentially involves fastening together the required number of cells to produce a vehicle of the required length and capacity, as illustrated in FIG. 5. Thus, FIG. 5a shows a vehicle having three cells, while FIG. 5b shows the addition of a cell to the three-celled vehicle, resulting in the four-celled vehicle shown in FIG. 5c. The cells are fastened together using fasteners such as bolts or rivets or alternatively, using bonding materials. In the preferred embodiment of the invention, the cells are permanently fastened together to produce a rigid vehicle of a fixed size. However, an embodiment is possible in which the cells are removably fastened together, allowing vehicles to be alterably configured.

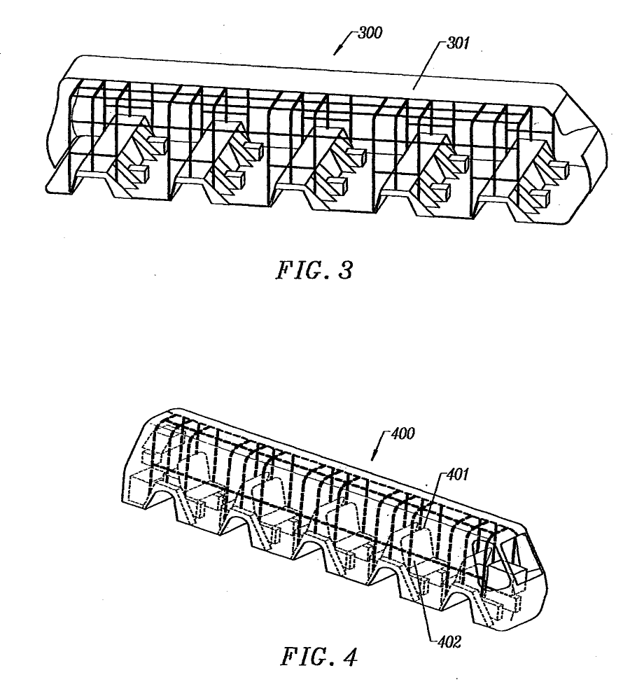

FIG. 3 provides a view of an assembled vehicle 300 minus axles and wheels, with a portion of the exterior cut away to reveal the frame. In the preferred embodiment of the invention, a lightweight frame is provided. The material for the frame may be a composite, or a lightweight metal product, such as aluminum. As described above, providing multiple independent suspensions, with a narrow span between axles, offers distributed support for the vehicle body, greatly reducing the load-carrying requirements of the frame and allowing it to be extremely lightweight. It should be remembered that the frame is incorporated into the individual cells, so that the frame shown in FIG. 3 was achieved by bolting four cells together.

FIG. 4 shows an assembled vehicle body with an exterior sunroof 401. Other embodiments having a solid roof with no sunroof are also possible. The vehicle 400 is also equipped with passenger seating 402. As previously described, the passenger seating is highly configurable, so that the seating capacity is readily increased or decreased. The smallest buses can have 14-20 seats and larger ones can have 45-55 seats. Seating can be provided in a conventional center aisle configuration, or in compartmented sections combined with center aisle sections. As previously indicated, automobile quality interiors permit the provision of a high level of passenger comfort, including individual seats, sound-deadening body and frame and insulation, and a compartment seating option.

Suspension

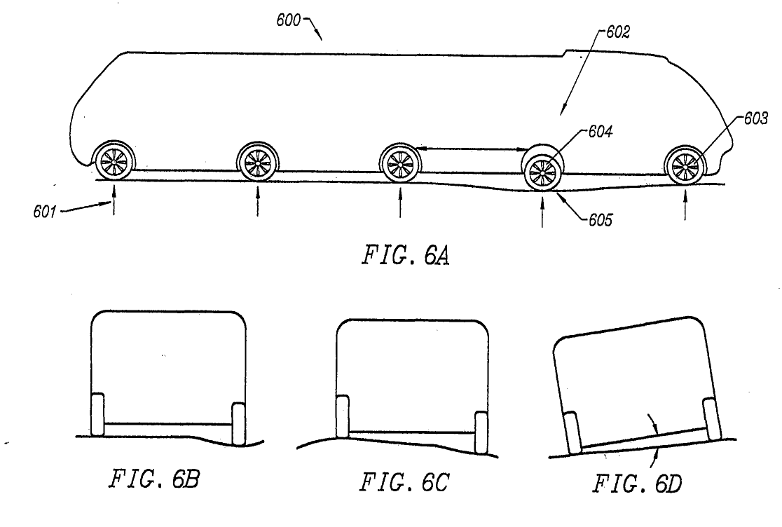

Referring now to FIG. 6, FIG. 6a shows a side elevation of a vehicle having five axles, in which each wheel 603 is coupled to its respective axle by means of an associated independent suspension. The multiple independent suspensions are positioned such that the span between two adjacent suspensions, indicated by arrow 602, is greatly reduced. Compared to conventional buses having two-axle or tandem-axle configurations, the current arrangement provides a number of important advantages. The narrowly- and evenly-spaced suspensions provide evenly-distributed support, indicated by arrows 601, to the vehicle body across the entire length of the vehicle, as opposed to only providing support at either end, as is usual in conventional bus vehicles. The distributed support is an important factor in providing exceptional ride stability. Thus, as the vehicle negotiates a dip 605 in the road, the evenly-spaced suspensions, coupled with the vehicle's rigid structure, transfers the load from the wheel 604 to the remaining wheels such that the vehicle stays level through the dip, eliminating the “porpoising” commonly experienced as buses traverse dips in roadways. Furthermore, novel active suspension elements, including height adjusters which move individual wheels up and down relative to the vehicle body, air springs with rapidly variable stiffness, and shock absorbers with capability to prevent dropping a wheel into chuckhole (for example) allow an exceptionally smooth ride as the vehicle encounters irregularities in the road surface. The distributed support provided by the multiple suspensions reduces the load carrying requirements of the vehicle structure, allowing the structure to be constructed with an extremely light design, using advanced material, as described above. Because load requirements of each suspension are greatly reduced, the vehicle suspension can be constructed from “off-the-shelf” automobile or light truck parts.

FIGS. 6b-6d illustrate the beneficial effect provided by including a height adjuster, described in greater detail below, as a component of each suspension. Under computer control, the height adjuster adjusts the height of each wheel relative to the body on a relatively slow time scale, maintaining all wheels in contact with the road and allowing the vehicle to negotiate large dips or large humps in the roadway. By adjusting the height of one side of the vehicle relative to the other, the passenger compartment can be made level in places where the road is not, thus preventing the vehicle from wallowing in a road depression as in FIG. 6b, and allowing it to remain level on a crowned road, as in FIG. 6c. Additionally, the height adjuster can allow the vehicle to lean into turns on the highway, as shown in FIG. 6d.

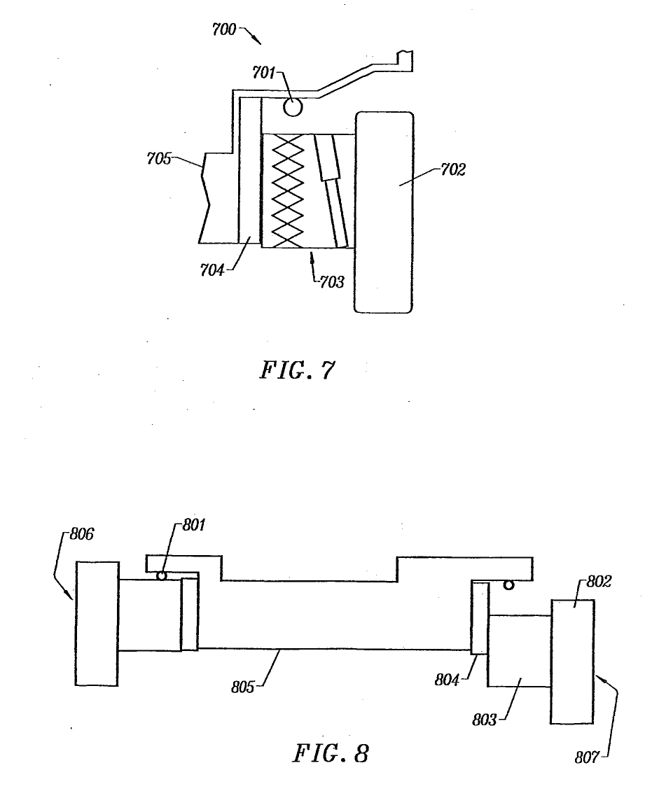

FIG. 7 provides a schematic diagram of a single suspension and associated parts for one wheel vehicle suspension. The suspension includes:
a ride bumper 701;
rotating elements 702, including at least a wheel, a tire, the rotating element of a wheel motor with bearing part, and the rotating element of a brake assembly;
non-rotating elements 703, including at least a control arm, spring, shock absorber, stabilizer, steering actuator and linkage, the fixed elements of brake and brake actuator, parts to mate with height adjustor assembly that is fixedly attached to the body or frame of the vehicle, the fixed element of the wheel motor with a bearing part, which also performs the function of an axle, mechanical structure and bearings/bushings as needed;
a height adjustor assembly 704, including mating plates, guides, bearings, actuator, mechanical structure fixedly attached to vehicle body/frame; and
vehicle body/frame structure 705 (integrating structure for floor, bulkhead, battery box and seat.

The individual suspension components are described in greater detail further below.

Referring now to FIG. 8, a schematic diagram shows how the independent suspensions integrate with the vehicle body/frame. The components listed above are shown in relation to the vehicles structural components:
ride bumper 801;
rotating elements 802;
non-rotating elements 803;
height adjustor 804,
body frame/structure 805.

The view provided in FIG. 8 is that looking toward the front of the vehicle. Thus, the left suspension 806 is shown with the wheel in its highest position relative to the body, and the right suspension 807 is shown with the wheel in its lowest position relative to the body.

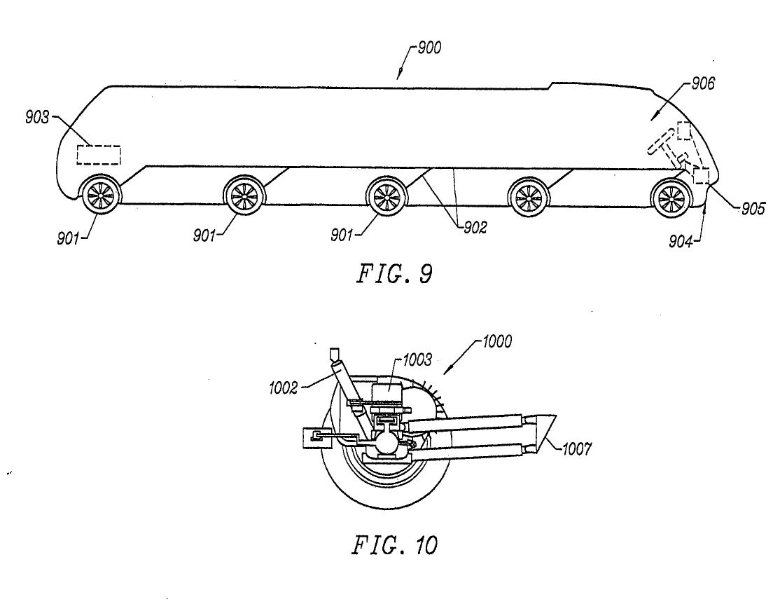

FIG. 9 provides a side elevation of a vehicle illustrating how the suspension system is integrated into the overall vehicle. As described in greater detail below, the suspension is processor-controllable, and accepts input from different sources. As described above, individual, independent suspensions 901 are provided for each wheel including:
tire;
wheel
axle;
height adjustor assembly;
spring;
shock absorber;
mechanical support;
sensors for suspension configuration;
sources of actuation force: hydraulic, pneumatic, and electrical; and
stabilizer and ride bumper.

One or more units 903 provide the actuation forces described above to the individual suspensions. Cabling 902 is provided for signal and electrical current transmission. In its preferred embodiment, the invention incorporates a wheel motor as described above for each wheel, the axle being integrated with the wheelmotor. An alternative embodiment of the invention provides a continuous axle as shown in FIG. 18, with a single drive motor for each axle. In the case of a continuous axle, the wheel assembly also includes a drive shaft, described further below. Control of the suspension is mediated through a microprocessor or controller 905, in concert with a signal processor element. Inputs to the suspension control system include those from the sensors already described, plus a road control sensor 905 and an operator interface 906.

Height Adjuster

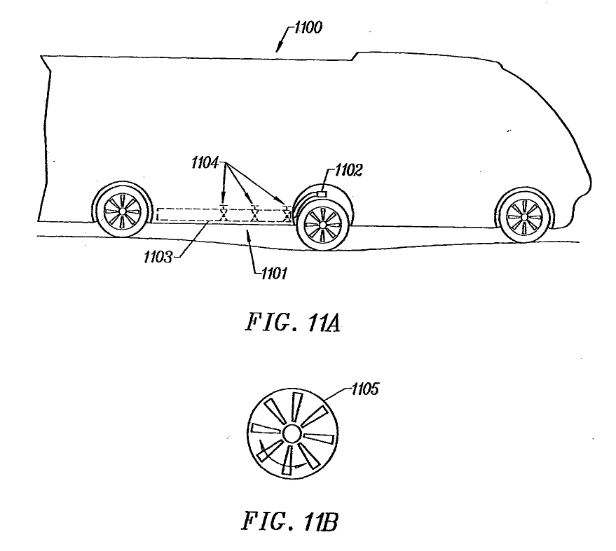

FIG. 10 provides a detailed illustration of the height adjuster system 1000 mentioned above. An important requirement of the vehicle suspension system is that each wheel moves up and down independently of all other wheels. This need is satisfied by providing trailing four-bar linkages 1001, actuated by pistons 1002. As FIG. 7 shows, the height adjuster linkage attaches to the floor of the vehicle, allowing the axle to move up and down when actuated. The preferred embodiment of the invention utilizes hydraulic pistons; however, a pneumatic piston would also be suitable. The four-bar linkage keeps the axle and all that is attached to it vertical without any tilting.

Air Spring

As shown in FIG. 7, the vehicle suspension includes an active air spring system. FIG. 11 shows a side elevation of a vehicle 1100 that includes an active air spring system 1101 as a suspension component. As previously mentioned, the suspension for each wheel moves up and down in relation to the vehicle body, with the body essentially remaining level and stationary. The height adjusters previously described provide the bulk of this vertical motion, particularly for the relatively slow operations described above, e.g., negotiation of large humps and dips, operation on crowned roads, and tilting into turns. In addition, the air spring has a long-stroke to smoothly accommodate substantial vertical wheel at higher rates of vertical travel. Because the action of the air spring is based on flow control and does not involve lifting the vehicle or working against dynamic loads, the air spring system is highly energy-efficient. The essential operating principle of the air spring system is that the body of the air spring 1102 communicates with a plenum 1103 through one or more progressive, fast-acting valves 1104. As shown in FIG. 1b, progressive valves 1104 are adjusted through the action of valve plates 1105 (FIG. 11b) rotated by a common shaft with cams at angular intervals. As more of the progressive valves are fully opened, the total volume of the air spring system is increased. Conversely, the more valves that are completely closed, the more the volume of the spring system is decreased. Spring stiffness is inversely related to the available volume within the system. Accordingly, with all valves closed, the spring has its maximum stiffness. Changing the spring stiffness does not itself change the force exerted by the spring. Thus, the air spring may best be characterized as a variable-constant air spring. The effect of making the spring softer is that as a wheel traverses a bump and the road lifts the wheel and compresses the spring, less added force (i.e., a smaller “bump”) is felt where the spring pushes up on the body. In actual practice, the air spring system can reduce bump force by a factor of five to ten. Additionally, the design of the air spring system allows it to be exceptionally fast acting, thus responding very rapidly relative to the time scale on which a change in spring stiffness must be implemented to respond to individual features of the road surface and optimize ride quality.

Active Shock Absorber

As FIG. 7 shows, the suspension further includes an energy-efficient, active shock absorber. The primary novel objective of the shock absorber is to slow or stop the violent vertical drop of a wheel into a sharp depression such as a chuckhole. As with the air spring just described, the shock absorber derives its energy-efficiency from the fact that its action does not involve doing work against the weight of the vehicle or dynamic loads, but instead involves control of fluid flow within the element by means of a fast-acting valve. Thus, the energy requirement is only that required to operate the valve.

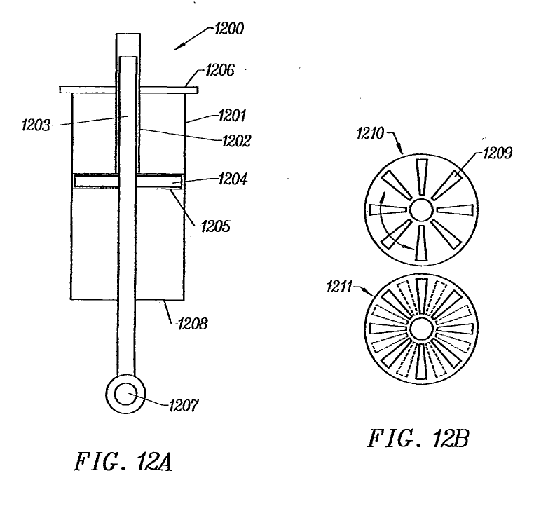

FIG. 12 shows the shock absorber 1200 in greater detail. The shock absorber includes a hydraulic fluid canister 1201 mounted to the top bearing plate 1206 of the spring. The mount has sufficient strength to cage the force of the fully loaded spring. The first end of a shaft 1203 is attached 1207 to the lower bearing plate of the spring. The other end of the shaft is received by a central opening on the lower face 1208 of the canister 1201 and traverses the volume of the canister axially to be received by a valve stem 1202 that concentrically surrounds the shaft 1203. A pusher plate 1204 is concentrically attached to the shaft such that the pusher plate is stationary and incapable of rotating. The pusher plate 1204 is enclosed within a valve plate assembly 1205, the valve plate assembly being continuous with the valve stem 1202. The valve stem emerges from a central opening in the top surface of the canister 1201 to be received by an actuator (not shown). It should be noted that the openings on both faces of the hydraulic canister are provided with fluid-tight seals to prevent the escape of hydraulic fluid from the canister and an attendant loss of pressure within the canister. Enclosure of the pusher plate 1204 within the valve plate assembly 1205 is achieved by sandwiching the pusher plate between two valve plates, upper and lower. Both the valve plates and the pusher plate are provided with openings 1209 (FIG. 12b). The valve plates are stationary with respect to each other, with the openings 1211 of each valve plate being aligned, and the two valve plates are stationary with respect to the valve stem 1203. The entire valve assembly, consisting of the valve stem 1202 and the valve plate assembly 1205, rotates freely with respect to the pusher plate 1204 and the shaft 1203, which remain stationary. Thus, the openings of the valve plates and the pusher plate may align 1210, either fully or partially, or they may be offset from each other 1211.

It may be seen that the combined pusher plate 1204 and valve plate assembly 1205 divide the hydraulic canister into two compartments. When the openings of the valve plate assembly 1205 and the pusher plate 1204 are aligned, fluid flow between compartments is permitted, according to the degree of alignment of the openings, and when the openings are offset, fluid flow between the compartments is prevented. Thus, by permitting fluid flow from one compartment to the other, the valve plates and pusher plates are allowed to move through the fluid in a piston-like fashion, as the associated spring is compressed or elongates. When fluid flow is completely obstructed by completely offsetting the openings of the valve plate assembly and the pusher plate, the shock absorber is stoppered and movement of the plates prevented. Accordingly, a variable amount of shock absorption is provided, determined by the degree of alignment of the openings.

As mentioned above, the valve stem is connected to an actuator. The actuator rotates the valve stem to set the alignment of the openings in the valve and pusher plates in response to input from the control system. It should be remembered that the suspension itself moves up and down in relation to the vehicle body, with the body remaining essentially motionless and level. The goal of providing the air spring and the shock absorber in the present configuration is to damp the upward and downward motion of each wheel, independent of all other wheels. Thus, closing the openings between the plates to retard fluid flow and restrict movement of the plates within the canister damps downward motion of the wheel in the following manner: when the pusher plate and valve plate alignment stops fluid flow, the plates push on the captured volume of fluid, pushing on the bottom of the container, thus resisting the force of the spring and the force of gravity on the wheel assembly.

The damping action of the shock absorber can be quickly optimized to best handle the particular features of the roadway surface, with shallow depressions invoking lesser responses in the damping action and chuckholes invoking complete stoppering. Unlike the requirement of a two-axle vehicle to be supported at all times at all four ends of the two axles, the invented multi-axle suspension allows one wheel temporarily to not support its full share of the vehicle weight, and the vehicle remains stably supported by the remaining wheels. An important difference between the current shock absorber and other active shock absorbers is that the action of transiently holding a wheel back from full contact with the road involves the resistance of the full force of the compressed spring.

Ride Bumper

As shown in FIG. 10, a ride bumper 1003 is provided that sits between the vehicle body and the axle during normal operation. The bumper is provided to maintain the axle at its required height in the event that the height adjuster fails. Also, the bumper can reduce wear on the height adjustor by supporting the axle at times when the height adjustor is unnecessary.

Control

Control of the height adjuster, the air spring and the active shock absorber is through a hierarchy of sensors with operator inputs involved only at the highest and lowest level. The active shock absorber activates via the computerized suspension control in response to a combination of information regarding rapid vertical acceleration of a wheel, rapid change of the vertical force on a wheel, and information from a road contour sensor. An optional operator input can alert the computerized suspension to an approaching road surface imperfection.

Steering

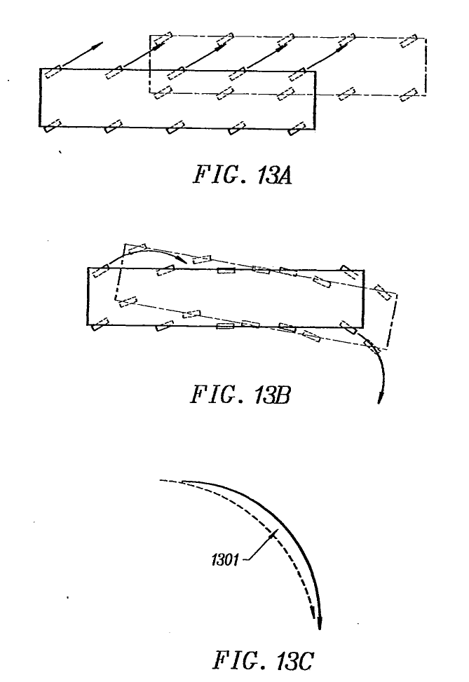

As mentioned earlier, it is necessary for urban transit vehicles to be easily maneuvered in a variety of restrictive settings: heavy urban traffic, narrow residential streets, and sharp corners requiring a narrow turning radius. For this reason, the invented vehicle is equipped with an all-wheel steering system that provides several steering modes. All-wheel steering allows the vehicle an exceptionally small turning radius relative to the vehicle size, rendering it highly maneuverable in the restrictive environments likely to be encountered in urban settings. In addition, as shown in FIGS. 13a and 13b, other steering modes are provided: crab mode (FIG. 13a) and pivot mode (FIG. 13b). Crab mode is particularly useful for maneuvering the vehicle into and out of tight parking spaces and moving flush to a curb, a frequent maneuver for transit buses. While crab mode requires that the several wheels of the vehicle be controlled in unison, the invention allows individual control of each wheel or each pair of wheels, thus permitting a pivot mode, extremely useful for turning especially tight corners or for turning the vehicle completely around in extremely confined spaces.

As described further below, multiple vehicles can be coupled to form trains, requiring a “rail” steering (FIG. 13c) mode in which successive units in the train tread in the same path as the first unit.

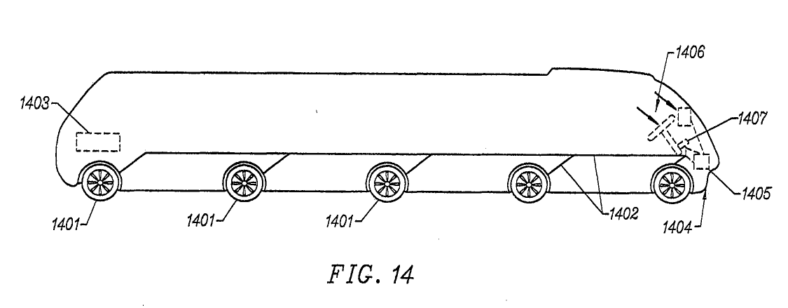

FIG. 14 illustrates schematically the components of the vehicle's all-wheel steering system. Similar to the suspension, there are wheel components, power sources, cabling, sensors, control elements, and operator interface:
Wheel components 1401: steering actuator and linkages, shown in greater detail in FIG. 18, required suspension, mechanical support, control arms, body/frame attachments, bearings/bushings, steering sensors;
Sources for actuating forces 1403: hydraulic, pneumatic and electrical;
cabling 1402;
road contour sensor 1404;
controller 1405
a transducer for steering control inputs;
an operator interface 1406; and
a display.

The first axle of the vehicle may also be controlled mechanically through the operator interface.

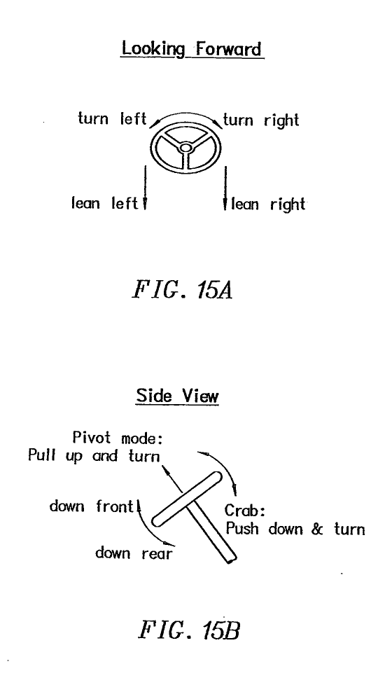

FIG. 15 provides an illustration of the vehicle's steering control interface. While steering could easily be controlled by way of a device such as a joystick, or even a computer pointing device such as a mouse, the preferred embodiment of the invention incorporates steering control functions into a modified steering column to minimize needs for special operator training. The simple interface allows the operator to engage different steering modes such as crab motion or tilting through simple manipulation of the wheel, without removing hands from the wheel to actuate switches or other controls. As FIG. 15 shows, ‘pivot mode’ is selected by pulling up on the wheel and turning in the appropriate direction. ‘Crab mode’ is selected by pushing down and turning. Turning is achieved in the conventional fashion, simply by turning the wheel in the desired direction. The height adjusters, for raising and lowering either side of the vehicle, are actuated using ‘lean left’ and ‘lean right.’ The ‘feel’ of the control is speed sensitive: turn, pivot and crab input forces stiffen with increasing speed, and the lean response increases with speed. The operator pitch input coordinates with the road contour sensor: the suspension controller can be set to anticipate road contours; ‘up/down front’ and ‘up/down rear’ anticipate entering humps and dips; and the control computer is informed by inputs from the actual suspension experience, the road contour sensor, and operator input. Control of individual axles or individual wheels is mediated through hydraulic or electric steering control actuators 1801 (FIG. 18) attached to each axle or each wheel.

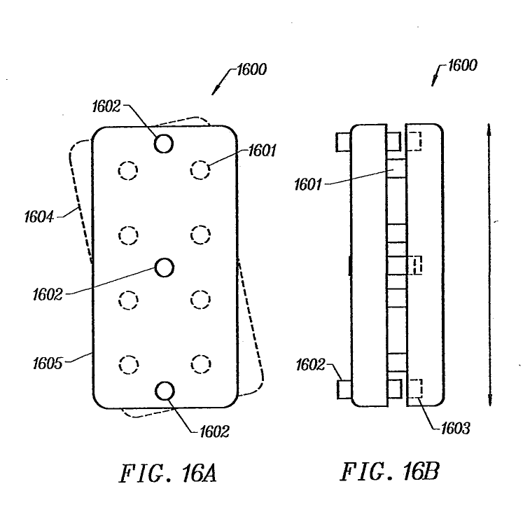

As shown in FIG. 16, the steering system includes a transducer to translate input from the operator interface to the signals required by the steering actuators. The transducer includes top 1603 and bottom halves 1604 (FIG. 16A) that move relative to each other. Steering mode selection pins 1602 are selectively engaged to set the steering mode. As shown in FIG. 16b, the central pin is engaged, allowing the top and bottom halves to twist relative to each other about the center pin, corresponding to ‘pivot’ mode. When none of the pins are engaged, corresponding to ‘crab’ mode, the top half moves sideways relative to the bottom half. To steer from the front, the operator engages the bottom pin, so that the top half of the transducer moves freely at the top. To steer the rear of the vehicle, the top pin is likewise engaged. Pushing the halves together evenly lowers suspension height, while drawing them apart raises the suspension. Either side of the vehicle may be raised and lowered by applying uneven force to either side of the transducer. Vehicle pitch is adjusted by twisting the top half of the transducer around a transverse axis relative to the bottom half. Roll is adjusted by twisting the top half of the transducer around a longitudinal axis relative to the bottom half. A transmitter 1603 emits a signal that drives the steering actuators through the mediation of the controller and the signal processor.

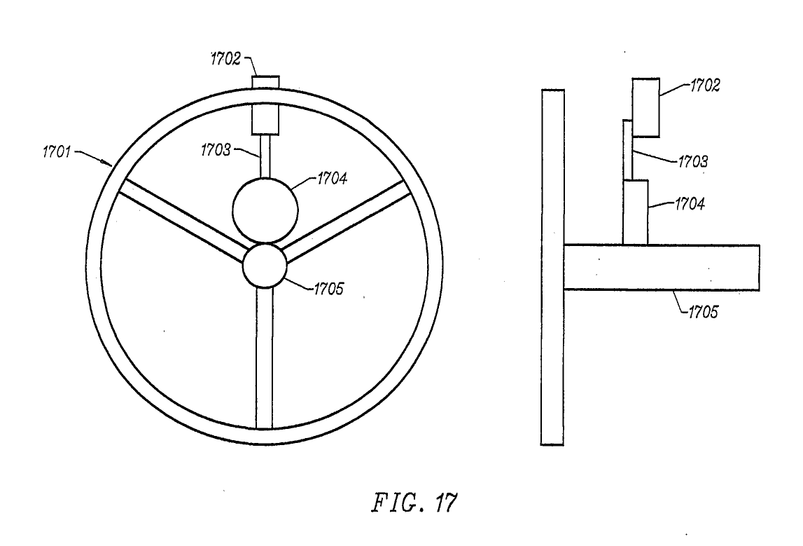

FIG. 17 provides a schematic diagram that illustrates the manner in which the operator interface is coupled to the transducer. The operator interface, in this case a steering wheel 1701 is coupled to the steering control transducer 1702 by means of a reduction gear 1704 and an arm 1703. The reduction gearing allows the steering wheel to retain the conventional feel of turning a steering wheel, shortening training times and facilitating acceptance of the vehicle by operators.

Drive System

As previously described, the vehicle derives its motive force from a hybrid power system that includes electric drive motors, translating members, a power plant for generating the electricity to drive the motors, and storage batteries.

Electric Drive Motor and Drive Shaft

While the preferred embodiment of the invention employs separate wheelmotors for each wheel, as described below, an embodiment incorporating a continuous axle has a single drive motor for each axle, as described immediately hereafter.

The vehicle's drive system includes a high-efficiency electric motor 1803 mounted on each axle, as shown in FIG. 18. Use of high-efficiency drive motors allows the contribution to overall vehicle weight by the motors to be minimized, while maximizing energy efficiency. A differential allows the motor to be run at its most efficient speed while allowing different rotation speeds for the wheels. Additionally, each drive motor 1802 requires a drive motor controller 1803, essentially a collection of very large power transistors that drive each winding on the motor, each controller driven by control software and further provided with diagnostic software. As shown in FIG. 18, the controller is mounted on the axle adjacent the drive motor.

Drive Shaft

It will be remembered that the preferred embodiment of the invention utilizes wheelmotors, a separate one for each wheel, with the axle being integrated into the motor. Accordingly, the preferred embodiment has no need of a drive shaft. However, alternate embodiments employing a continuous axle require a drive shaft as described below.

Power is transmitted to the wheels from the differential through a drive shaft. The drive shaft includes two shafts coming out of either side of the differential, each connected to a CV joint, which is, in turn, connected to a half shaft that is connected to the respective wheel through another CV joint.

Power Plant

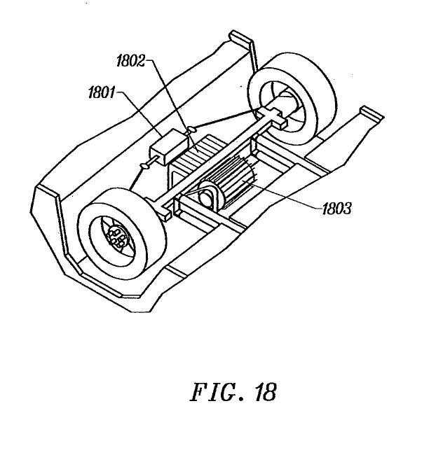

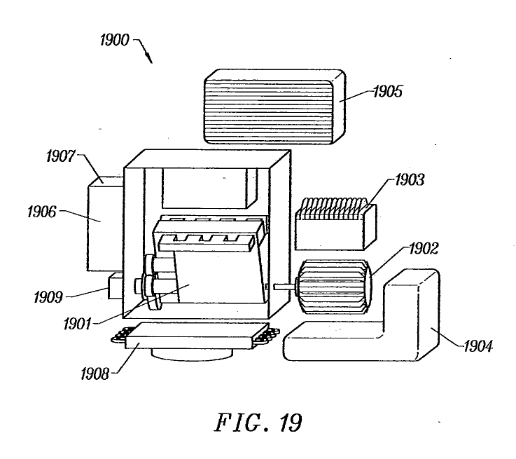

The major components of the vehicle's power plant 1900 are shown in FIG. 19. The entire system is mounted in the rear section of the vehicle. The power system includes:
an engine (1901)—The engine is the basic power source for the vehicle. The current embodiment of the invention includes an internal combustion engine. The vehicle preferably uses an environmentally friendly fuel such as natural gas or liquid propane. However, due to the high fuel economy of the vehicle owing in part to the hybrid-electric power system, even an internal combustion engine employing conventional petroleum fuels such as gasoline or Diesel fuel greatly minimizes the deleterious environmental effects caused by fuel emissions. Moreover, embodiments of the invention powered by alternative energy sources such as fuel cells or hydrogen are also possible;
a fuel tank (1904);
a generator (1902): power from the engine is converted to electricity via the generator. The generator is attached directly to the engine's drive shaft;
a generator controller (1903): the generator requires a control element to capture generated electricity properly and to control battery charging in concert with a corresponding controller in each battery pack;
a cooling system for the engine (1908);
a hydraulic unit (1906): a hydraulic pump and controller are connected directly to the drive shaft of the engine. This unit provides hydraulic power, at least for the height adjuster system, the steering and braking systems;
a pneumatic unit (1909): an air compressor and controller are connected directly to the drive shaft of the engine. This unit provides compressed air, at least for the air spring system, and to a pneumatically powered height adjuster as an alternative to the hydraulic power system for the height adjuster system, and other ancillary vehicle subsystems.
an engine box (1907); and
a climate control unit for passenger areas (1905).
   Battery Packs

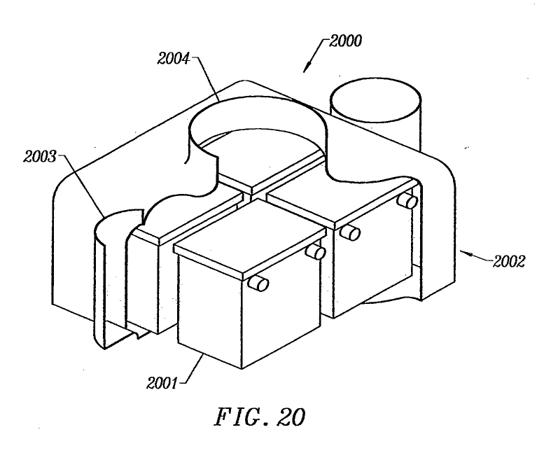

The power system requires a number of storage batteries positioned at regular intervals about the vehicle; in the preferred embodiment of the invention the battery packs are situated over the axles (i.e., in the body between pairs of opposing wheels on opposing sides of the vehicle), including the first and last axles. FIG. 20 shows a battery pack 2000 having a number of batteries 2001. Four batteries are shown in FIG. 20; however, this is merely for the sake of illustration. The actual number of batteries may vary according to battery capacity and vehicle power requirements. The batteries generate a significant amount of heat, requiring the provision of an inlet vent 2004 in the battery pack housing 2002 to cool the batteries. Because the batteries may create fumes that are potentially hazardous, the battery pack is vented to the outside environment by means of one or more outlet vents 2003. Each battery pack also contains an electronic controller that controls charging, monitors health of the battery pack, and communicates with the generator controller.

System Command & Control Computer

As previously mentioned, control of many of the vehicle's systems is processor-mediated: the suspension, the all-wheel steering system, and the hybrid power system. In some cases, control is by means of local controllers, the power plant for example. Some of the vehicle systems may accept a variety of inputs. The vehicle includes other control systems not previously described:
a door system controller;
a fare system;
a security system;
a climate control system; and
a communication system.
   Thus, a central command and control system is required to control and mediate the interaction of the various system controllers.
   Coupling Several Vehicles to Form Trains

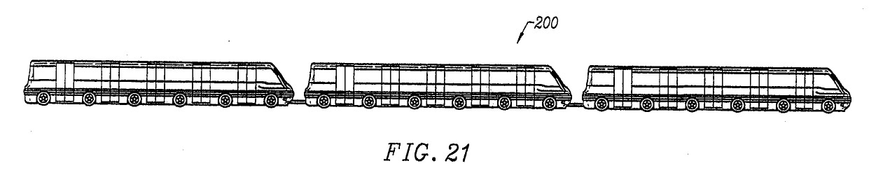

As FIG. 21 shows, several vehicles may be combined to form trains 2100. The train is made possible by the vehicle's control system, including controls for steering, suspension, propulsion, and passenger needs. Requiring primarily linkage of the control systems of individual units into coordinated units of a train (and not links to provide inter-unit towing or mechanical guiding forces), buses may be linked and de-linked very rapidly. The bus train provides the advantage of carrying as much passenger traffic as a train of light rail vehicles without requiring the infrastructure scale of a light rail system. The bus train requires essentially no infrastructure other than passable roadways such as principal streets or boulevards in major urban areas, i.e., roadways that lack extremely tight turns. A train of these bus units may pass wherever a single unit can since the vehicle's steering control allows successive units in a train to tread in the same track as the first unit over the road. A bus train is driven by one driver, thus, a single driver can transport at several times the number of passengers as in a single vehicle, enabling a significant reduction in labor cost.

For operation as part of a train, the steering systems of successive units are set in ‘rail mode,’ (FIG. 13c) in which the wheels behave as if they were on rails, treading in the same path on the roadway as those of the first unit, instead of cutting 1301, as conventional trailing wheels do. The additional data required by the steering control system to operate in ‘rail mode’ are relatively minor—the distance from the first axle of the first unit to the first axle in the second unit, and so forth. In ‘cattle car’ mode, common in current mass transit vehicles, multiple doors make it possible to accommodate approximately 20 passengers per door, at least for short distances, or 80 passengers per 4-compartment bus and 240 passengers per 3-unit train. For high volume routes having straight streets, 5-unit trains are practical.

Swingarm Embodiment

Multi-wheel suspension is the key to the extensive list of benefits of the previously described embodiment of the invention. Preferably, a multi-wheel suspension provides each wheel a relatively long vertical travel to allow the vehicle to pass over humps and dips in the road, so that the wheel has for example, an adequate breakover angle.

Ideally, such a multi-wheel suspension will include at least some of the following characteristics:
Large vertical motion
Practicality of steering all wheels;
Low unsprung weight, which helps to engineer a smooth and stable ride;
Compactness, for minimum intrusion into the passenger/payload area;
Low parts count and low cost part; and
Durability and easy maintenance.

Swingarm suspensions provide numerous advantageous features and benefits that help to meet such functional objectives:
long wheel travel with short spring stroke
reduced space requirements
fewer parts
less weight
less cost; and
Maximum entry and departure angles.

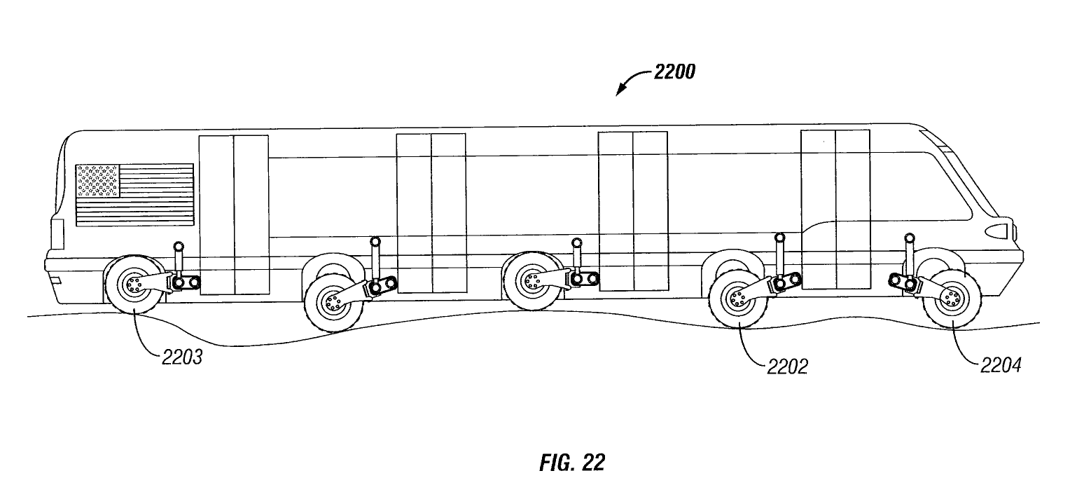

FIG. 22 shows a transit vehicle having five pairs of wheels equipped with swingarm suspensions. The figure illustrates the ability of swing-arm suspensions to be compact, which is important for minimizing the intrusion of the wheel and suspension housing into the volume intended for payload. The figure also illustrates the ability of swing arm suspensions with identical designs to be used at all wheel locations, which gives important advantages for economical manufacturing and maintenance.

The light weight of these suspensions owes in large part to the ratio of the lever arms from the pivot points of the arms to, respectively, the attachment of the spring/dampener and the lever axle of the wheel. This length ratio is proportional to the ratio of spring stroke to wheel travel. Shorter spring travel means a shorter, lighter, and more compact spring and dampener assembly. The forces involved in the spring are especially matched by the technology of modern pneumatic and fluidic devices.

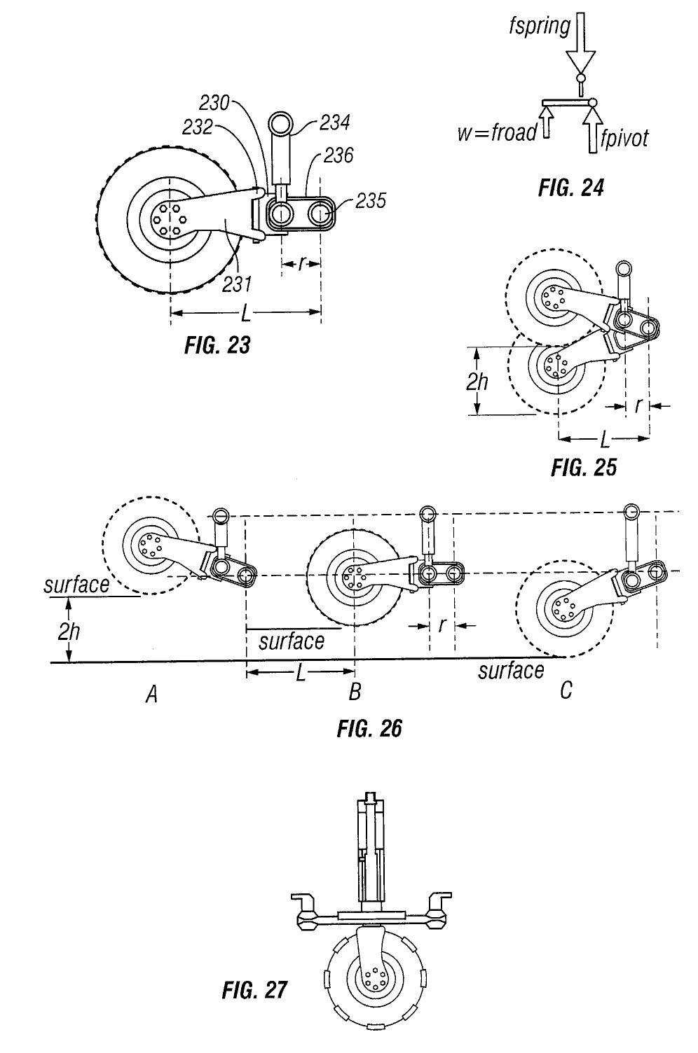

FIG. 23 shows an embodiment of a swing arm suspension and defines the major geometric parameters, notably 2 h (see FIG. 26), the total vertical travel of the wheel. The illustration shows that the main elements of a swing arm suspension 230 with steering means include at least:
Fork (231);
King pin (232);
Upper/lower steering arms and actuation means (233);
Spring and dampener (234);
Swing arm (236); and
Swing arm pivot (235).

The forces and moments involved in the swing arm suspension are illustrated in FIGS. 23 and 24. In these figures, w=weight supported by the wheel, f_{spring}=the force in the spring, L=distance from the pivot to the center of the wheel, and r=distance from the pivot to the spring. FIG. 24 illustrates the amplification of the force in the spring that accomplishes the spring's compactness by reducing the spring extension.

Also desirable for achieving maximum advantage from the multi-wheel suspensions is adjustment of the neutral vertical position of the wheel relative to the body. Such adjustment may be adjustment of the neutral position of the suspension by hydraulic or other means that move the attachment point of the spring vertically.

FIG. 25 shows a superposition of the swing arm suspension in the three main vertical positions: neutral, up and down. These three positions are shown separately in FIG. 26. In FIG. 25, the three drawings of the three main positions are aligned vertically according to the mounting points of the spring/dampener and the swing arm's pivot bearing. FIG. 25 illustrates:
the motion of the wheel relative to the body of the vehicle, and
the basic action of the swing arm suspension elements. The representations of the three positions highlight the ratio of the vertical motion of the wheel to the extension and compression of the spring/dampener.

In an alternative embodiment, FIG. 27 shows an alternative suspension that is also steerable and capable of the necessary large vertical wheel travel. This in-line suspension is included for reference to illustrate the relative compactness of the swing arm design. The primary trade-off between the embodiment in FIG. 27 and the swing arm suspension is between the compactness, low cost, and low unsprung weight of the swing arm suspension versus the relative ease of steering the in-line suspension by angles up to 90 degrees, and even more.

Lightweight Hybrid Surface Vehicle

While previously described embodiments of the invention are directed primarily to transit vehicles, such as busses, the principles of the invention elucidated above are readily applicable to other lightweight surface vehicles, the automobile for example. Thus, the platform for sustainable transportation can extend to provide an automobile-type surface vehicle providing at least the following advantages:
Crash safety;
Low cost to build;
Low cost to operate;
Ultra efficient with minimal environmental impact;
Transformer body coverings;
Distributed manufacturing;
Versions suited to urban and rural driving; and
Models for light duty, highest economy to high capacity, stylish markets

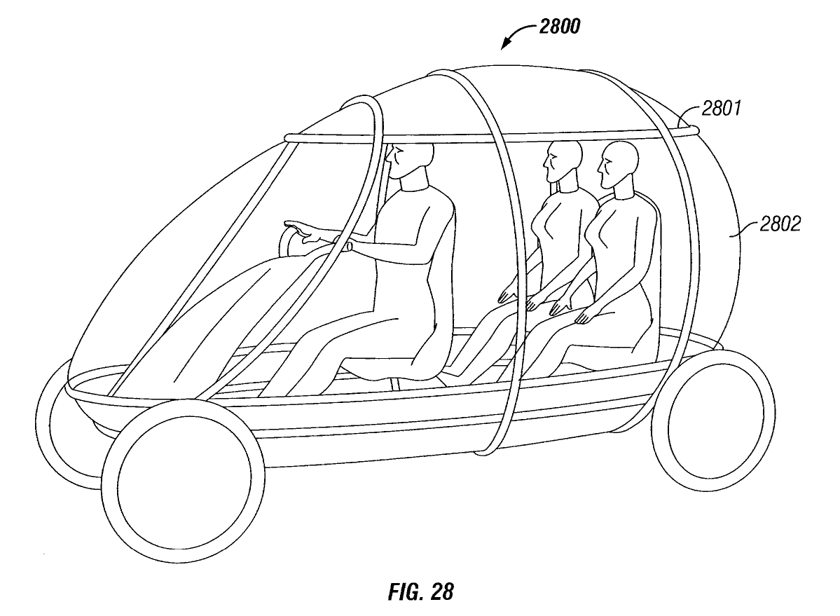

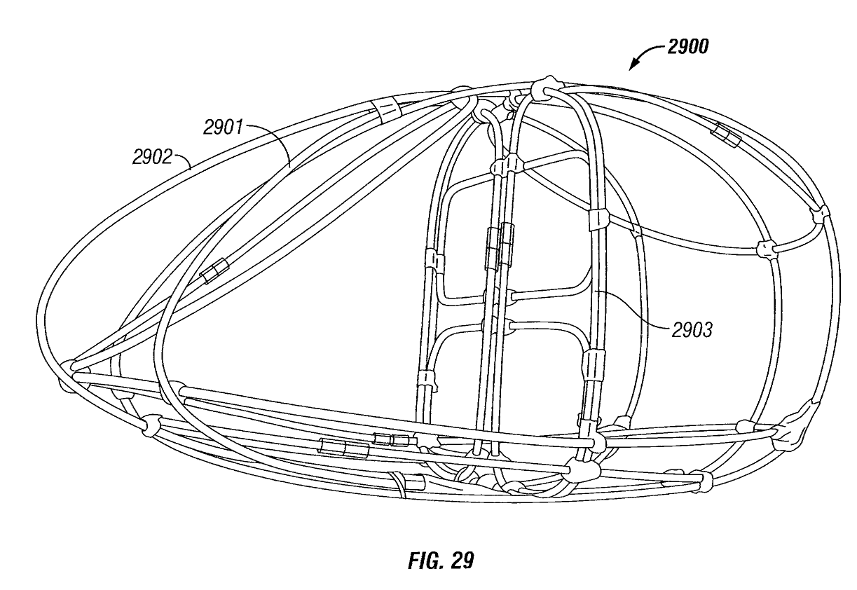

The principles of design simplicity and manufacturing simplicity hold out the possibility of providing high quality, high-utility production vehicles at low cost and in high volume. Accordingly, the invention provides a lightweight automobile-type surface vehicle 2800 (FIG. 28) having the following characteristics and advantages
Attractive and interesting appearance;
“Transformer” body coverings;
Readily manufacturable using distributed manufacturing techniques;
Versions suited to all urban and all rural driving;
Models for light duty, highest economy to high capacity, stylish markets; and
Environmental friendliness maximized.

The embodiment shown in FIG. 28 incorporates the above principles and characteristics includes at least the following advantages, features, assemblies, systems, and/or parts:
High utility;
Crash safety provided by tubular space frame roll cage (FIG. 29);
Aesthetically pleasing exoskeleton-type external structure 2801;
High quality in a production vehicle;
Ultra-efficient and ultra-clean: powered by one or more ultra lightweight electric motors with series electric-hybrid, parallel-electric hybrid, and plug-in electric-hybrid driveline options;
Low operating costs: low fuel use, simple maintenance with low cost replacement parts
Manufacturable from lightweight commercial off-the-shelf parts, for example bicycle parts; and
“Transformer” body coverings that can be removed and swapped out by the vehicle owner 2802;
Low cost to build: preferably no more than half the cost of the smallest, lowest-priced cars;
Environmental friendliness maximized by minimum materials requirements;
Readily manufacturable using highly distributed manufacturing techniques;
Versions suited to a variety of urban and rural driving markets; and
Three- and four-wheeled versions.

The various systems of the exemplary embodiment are described in greater detail herein below.

FIG. 29 illustrates a roll cage frame 2900 for the vehicle of FIG. 28. As shown, the structure provides both a centerline frame 2902 and an x-frame 2901. One embodiment of the invention requires only the x-frame. Preferably the structure 2900 is fabricated from a tubular material. In one embodiment, the tubular material is a metal. However other materials, such as polymers and or composites, may occur to the practitioner having an ordinary level of skill and are within the scope of the invention. In the present embodiment, the various frame elements and bulkheads 2903 are assembled using fastening elements such as coupling sleeves. Other fastening elements such as bolts would also be suitable. Other suitable fastening means may occur to the practitioner having an ordinary level of skill.

Propulsion System

Series-hybrid or parallel-hybrid with on-board, electricity generator, battery system, and one or more electric drive motors.
Plug-in hybrid: for example: battery rechargeable from hybrid generator or wall plug;
Generator output provides continuous cruise power and recharges battery;
Battery provides peak power for acceleration and hills;
Hybrid electric vehicle motor and motor controls, the exemplary embodiment incorporates for example a 10 kw motor;
Lead-acid, deep-cycle battery, spiral wound for vibration resistance;
Alternative advanced battery such as lithium ion;
Hybrid battery capacity my be small or optionally sized for desired zero-emissions vehicle range;
High ratio of Payload carrying capacity to Gross vehicle weight rating (GWVR) allows for a relatively heavier battery pack;
Battery charger: manufactured with inverters;
Standalone electric generator products; and
Electric generators portable from vehicle to worksite or home.
   Driveline
Rear-wheel drive;
Solid drive axle under rear seat;
Belt drive from motor to drive axle;
Derailleur-type belt shifter between larger and smaller pulleys: two- or three-speed ratios;
Belt drive sprockets on ends of drive axle are preferably concentric with swing-arm bushing;
Final driveline gear ratio between sprockets on drive axle and wheels.
Alternative electric hub-motors on all-wheels, rear-wheels only, or front-wheels only.
   Tubular Frame Structure
Exoskeleton space-frame 2801 strong and aesthetically pleasing
Tubing on surface, floor, seating and bulkheads 2903 totally integrated;
Light weight provides benefit to propulsion system;
Low material weight, low cost;
Low tooling costs;
Simple assembly; and
Optional assembly from kits with minimal special skill or tools.
   Body Coverings: Panels and Windows 2802
Low-cost;
Coverings quickly attached, removed and switched, replaceable;
Provided in a range of panel configurations so that owners can personalize vehicles;
Large assortment of fabric coverings: for example fabrics from padded and insulated to light and ventilated, plastics, metals;
Belly pan options: plastic, sheet metal, thin plastic or metal over sound-deadener and/or insulation;
Vehicle has the ability to float;
Flexible and/or rigid plastic window options.
   Suspension 3003, 3004
Swing arms giving wheels long strokes via spring and shocks with short strokes;
Designed and built around commercial off-the-shelf (COTS) parts and easily built parts;
Trailing link rear suspensions 3004, preferably assembled from COTS bicycle parts;
One or more leading-link front suspensions 3003;
Long wheelbase provides high ride pitch stability;
Fork suspensions are steerable through incorporation of a steering bearing in the fork mount;
Either bicycle or motorcycle wheels 3005, tires and brakes, according to vehicle weight;
All suspensions are preferably identical, which provides a further reduction in manufacturing cost.
   Steering
Leading-link steering configuration;
Pivot member and steering arms to effect conventional steering geometry of rotation of wheel plane about its vertical axis;
Optional added feature for steering geometry by addition of bearing to permit rotation of wheel plane about its fore-aft (roll)-axis;
Wheel tilt toward turn center of curvature increases stability;
Preferably, axis of fork's steering bearing approximately seventy percent below height of wheel's axle;
Tilt angles of less than 0.2 radian (12°) for the tightest turns;
Neutral or self-centering steering for small tilt angles in straight-ahead driving;
All suspensions are preferably identical and all wheels may be steered in the same manner as the front;
Embodiments of the invention providing all-wheel steering are possible.
Embodiments having six, or eight or more wheels are also possible.

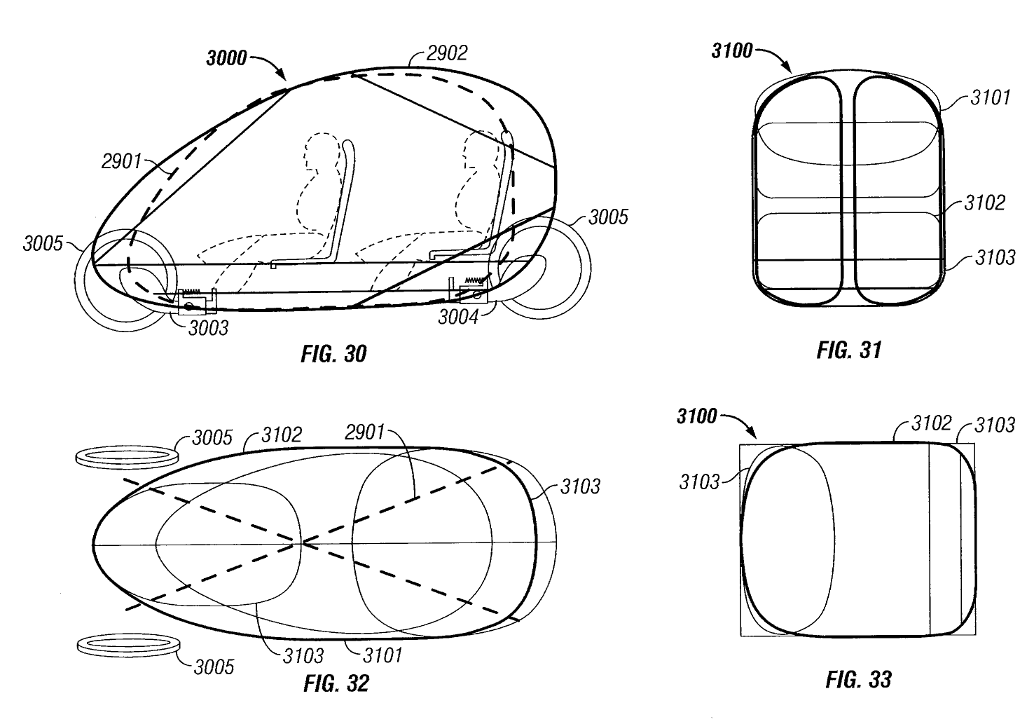

FIG. 30 provides a section view of the vehicle of FIG. 28, illustrating attachment of the suspension to the frame 2900. As above, the frame 2900 includes x-frame 2901 and centerline frame 2902. At the front of the vehicle, leading link suspensions 3033 are attached to the frame 2900. In the rear, trailing link suspensions 3004 are attached to the frame 2900. Front and rear axles attach to the suspensions 3003, 3004. As above, one embodiment provides rear-wheel drive. Accordingly, the rear axle fulfills the role of drive axle. Embodiments of the invention incorporating front-wheel, four-wheel or all-wheel drive are also within the scope of the invention. In one embodiment, the drive axle is a single axle, wherein wheels 3004 are attached to the opposing ends of the axle. Additional embodiments provide independent drive axles for each wheel. As to the front axle, embodiments are possible wherein each front wheel 3005 has its own axle. Additionally, it is possible to provide a single front axle wherein the front wheels 3005 are attached to the opposing ends of the single front axle. Alternatively, as above, hubmotors may be provided on all wheels, front wheels only, or rear wheels only.

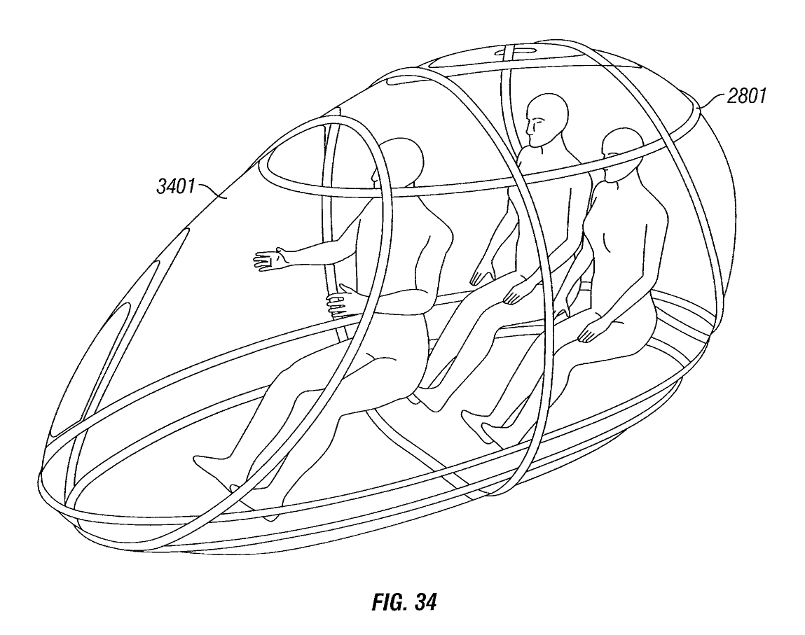

As previously described, the frame 2900 includes at least one bulkhead 3101. FIGS. 31 and 33 provide views of a bulkhead pillar frame 3100. The bulkhead pillar frame includes a waterline frame 3102 and a false-bottom frame 3103. FIG. 32 provides a plan view of the vehicle of FIG. 30, showing the orientation of the front wheels 3005 in relation to the frame 2900 in greater detail.

FIGS. 34 to 39 provide a series of views of the various body panels, doors and windows attached to the external frame.

FIG. 34 illustrates a front windshield 3401 attached to the frame 2801.

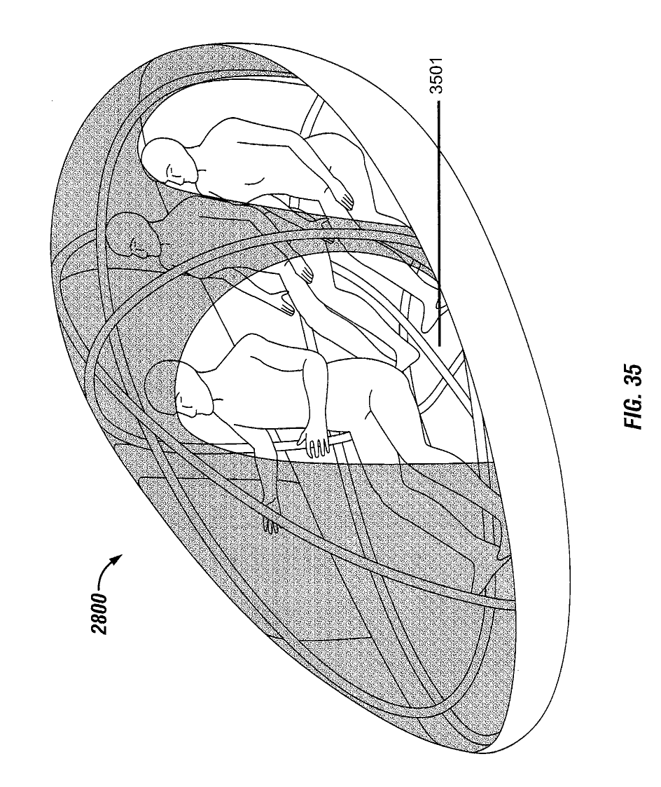

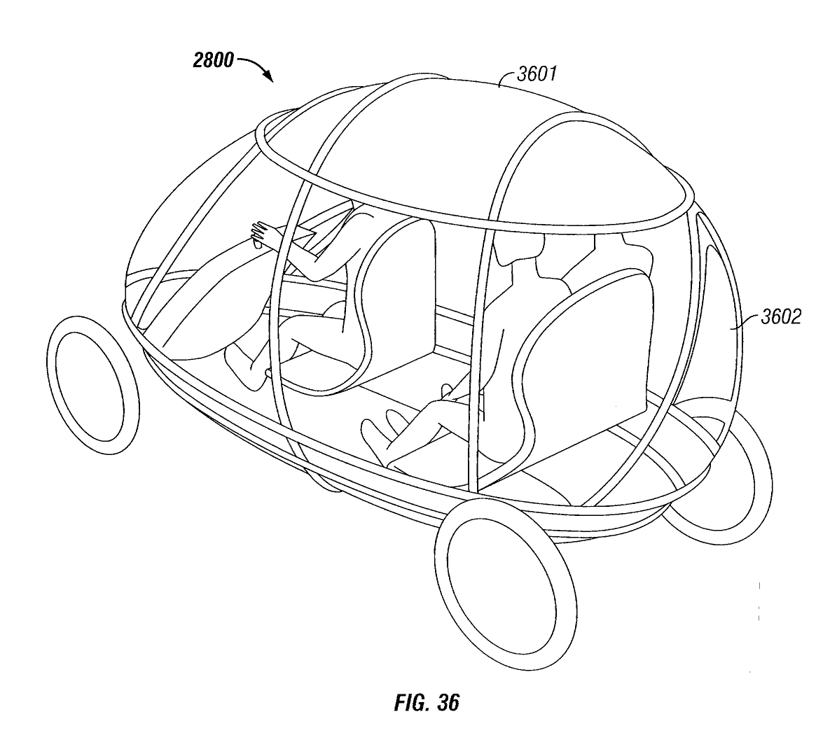

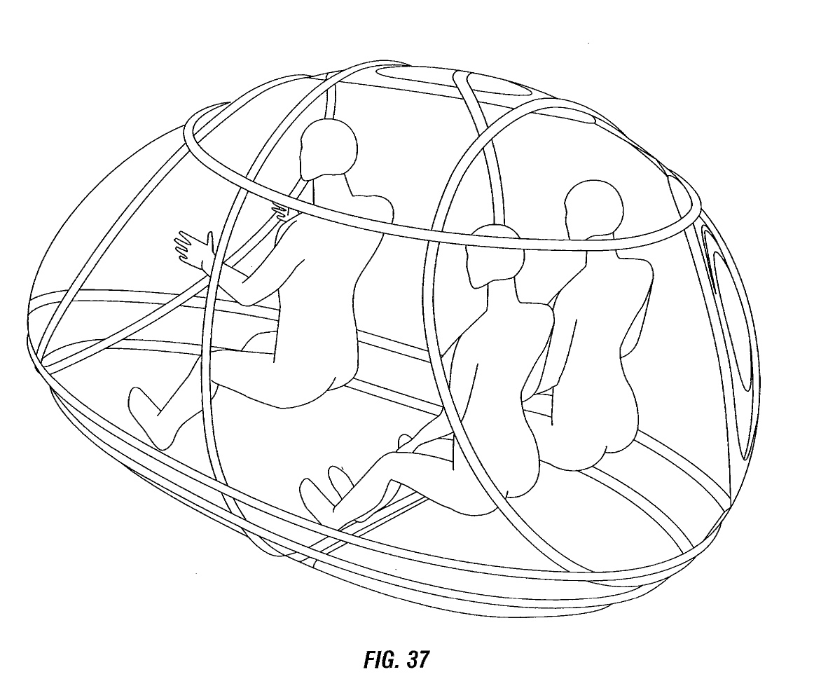

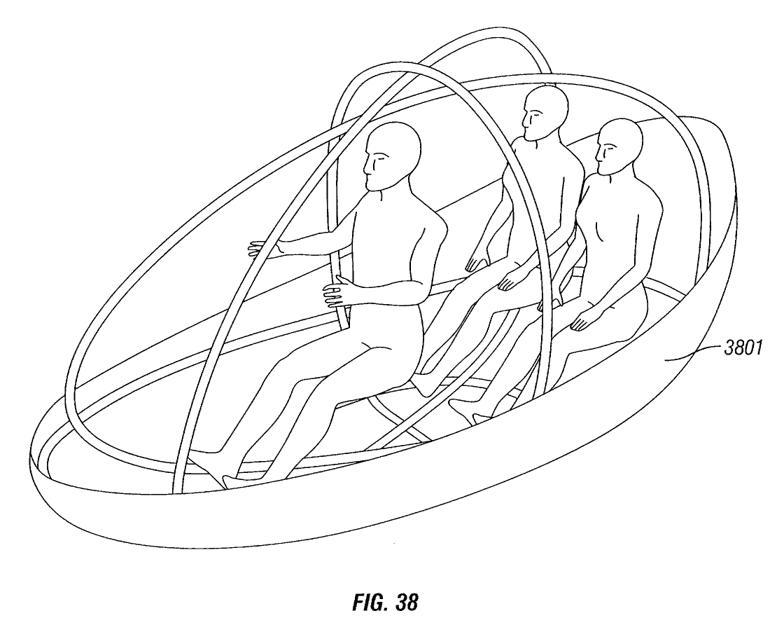

FIG. 35 illustrates the vehicle 2800 of FIG. 28 with x-frame members and door opening 3501 provided.

FIG. 36 illustrates the vehicle 2800 of FIG. 28 with top panel 3601 and rear window 3602 attached.

FIG. 37 provides a rear view of the vehicle 2800 of FIG. 28.

FIG. 38 shows a bottom shell 3801 for the vehicle of FIG. 28 shown with x-frame.

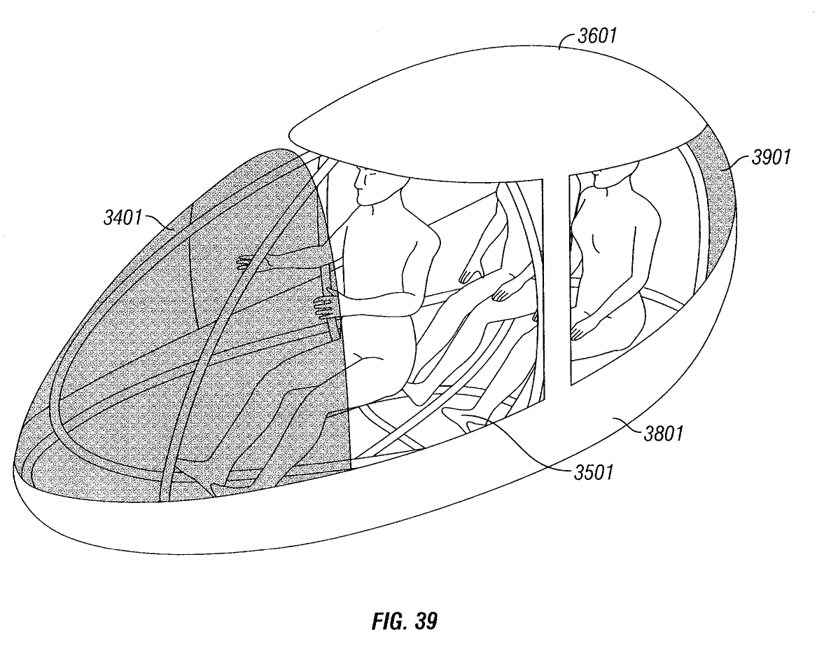

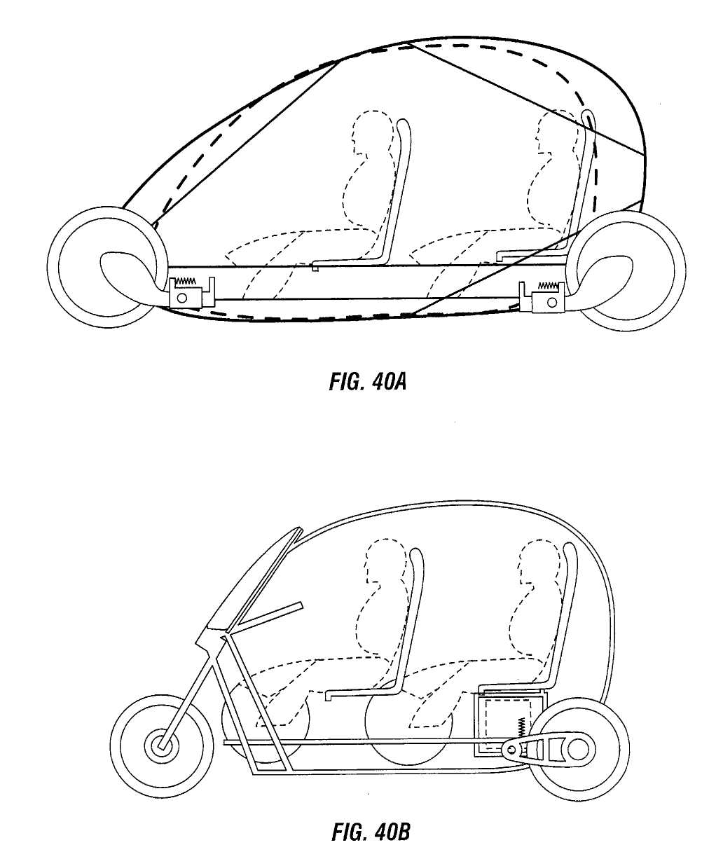

FIG. 39 shows the vehicle of FIG. 28 with x-frame and top panel 3601, rear window 3901, bottom shell 3801, door opening 3501 and windshield 341 attached.

As described above, the invention includes three and four-wheeled embodiments. FIG. 40 provides side section views comparing a four-wheeled vehicle (A) with a three-wheeled vehicle (B). It should be noted that the three-wheeled vehicle is simpler, smaller and lighter weight. For example, the wheelbase is noticeably shorter. Additionally, the lighter weight vehicle dispenses with the centerline frame, providing only x-frames. Additionally, the front wheel is mounted in a fork, as would be the front wheel in a bicycle or motorcycle. In fact, the principles of the invention can be applied to bicycles and motorcycles to provide additional embodiments of lightweight, sustainable surface vehicles.

Bicycles and Tricycles

In addition to the three-wheeled embodiment described above, the invention also includes three-wheeled vehicles that are essentially power-assisted tricycles.

In some parts of the world, lightweight, human-powered three-wheeled vehicles are widely used, in agriculture for example. It would be an important improvement to provide a power-assisted version of such that relies on electric and hybrid technologies. Accordingly, the invention provides all-weather electric and hybrid tricycles that include passenger protection from the elements to provide extremely lightweight and low-cost utility and transportation vehicles. Vehicles intended primarily for utility may have only one seat, whereas passenger vehicles could seat up to three passengers.

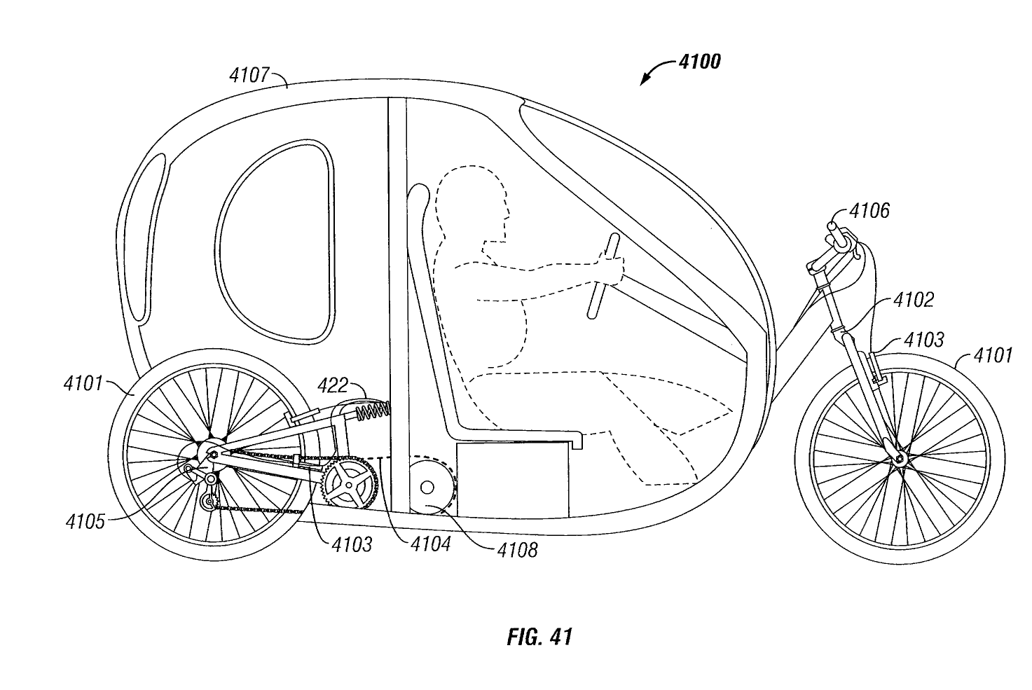

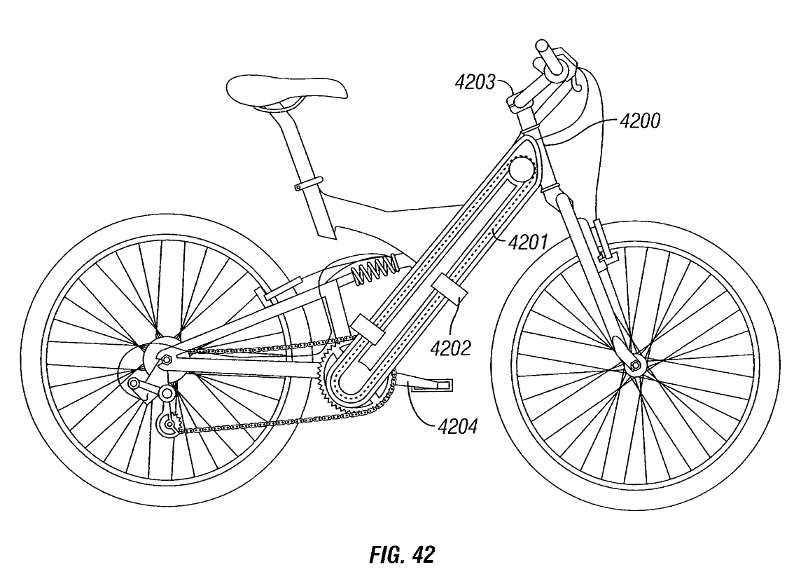

FIG. 41 shows a single-seat electric tricycle. The vehicle 4100 includes bicycle wheels 4101, bicycle suspensions 4102, brakes 4103, chain drive 4104 and gear shifters 4105 and handlebar controls 426.

Additionally, the vehicle includes a body 4107 that provides occupant protection through incorporation of the roll cage previously described, a smooth suspension & comfortable ride, attractive design statements, designed to be personalizable by owners with or without OEM (original equipment manufacturer) parts.

Other systems of the vehicle include:
Propulsion integrated with bicycle chains, sprockets, shifters, etc.
Off-the-shelf generator:
Motor and Controls:
an electric motor 4104
“Exo-skeleton” roll-cage:
Prototype materials and bending selected for low product cost and facilitation of distributed manufacturing.
Tube joining concepts designed for low investment, easy assembly.
Suspension, steering, brakes:
Body coverings easy to attach/remove/alter
Sides and top: Fabric. Plastic later.
Upgrades options for high thermal and sound insulation.
Bottom surface fiberglass watertight to “waterline”
Windshield options.

Bicycles assisted by electric motors are in widespread use worldwide. The energy to run the motors is principally chemical batteries. As with all such uses of chemical batteries, the first and replacement costs are significant factors, and means to extend the lifetime are desirable. Principle factors limiting battery life are high rates of charging and discharging and the deep discharge or extreme topping off to maximize available energy per battery charge. Thus, relieving the electric motor from some of the peak power requirements promotes long battery life by reducing peak currents. The bicycle rider conventionally pedals to help accelerate. Because the use of mechanical brakes to slow down and stop liberated a substantial amount of energy, an embodiment of the invention if possible wherein a bicycle is provide with a system for regenerative braking. Alternative power boosting means that can be combined with both pedal and battery power would be beneficial to both rider and battery as a tertiary energy source, and may possibly replace the electric system for reasons of performance or cost or both.

An embodiment of the invention includes a Pneumatic Pedal Assist PPA™ that uses a compressed gas as the energy storage medium. Through the action of a piston driven by the compressed gas, mechanical or fluidic (hydraulic) means may be used to couple the energy from the storage chamber to the driveline. Fluidic means entail a fluidic motor that is reversibly run as a pump to return the energy to the compressed gas and store it there as needed.

The Pneumatic pedal assist is mainly functions to help provide peak power requirements, because: (1) The energy storable in compressed gas is relatively smaller than that storable in batteries, and (2) pneumatic means are effective for rapid discharge or charge, which does not accelerate their wear or reduce their lifetime. To minimize cost, space, and weight to implement the PPA™ system, energy storage may be accomplished by using the tubular frame members of the bicycle as gas containers as well as structural members.

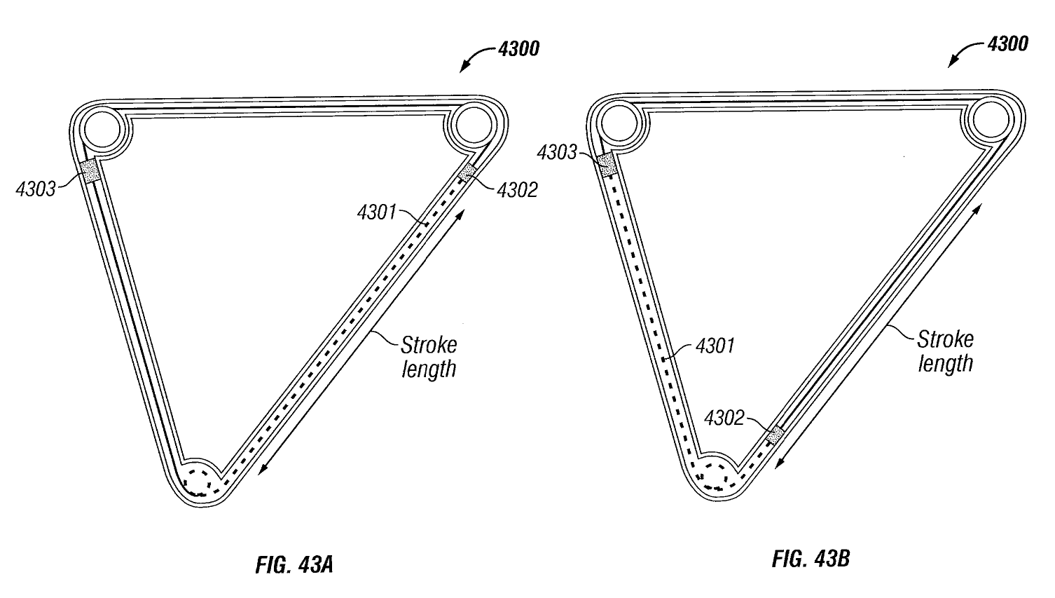

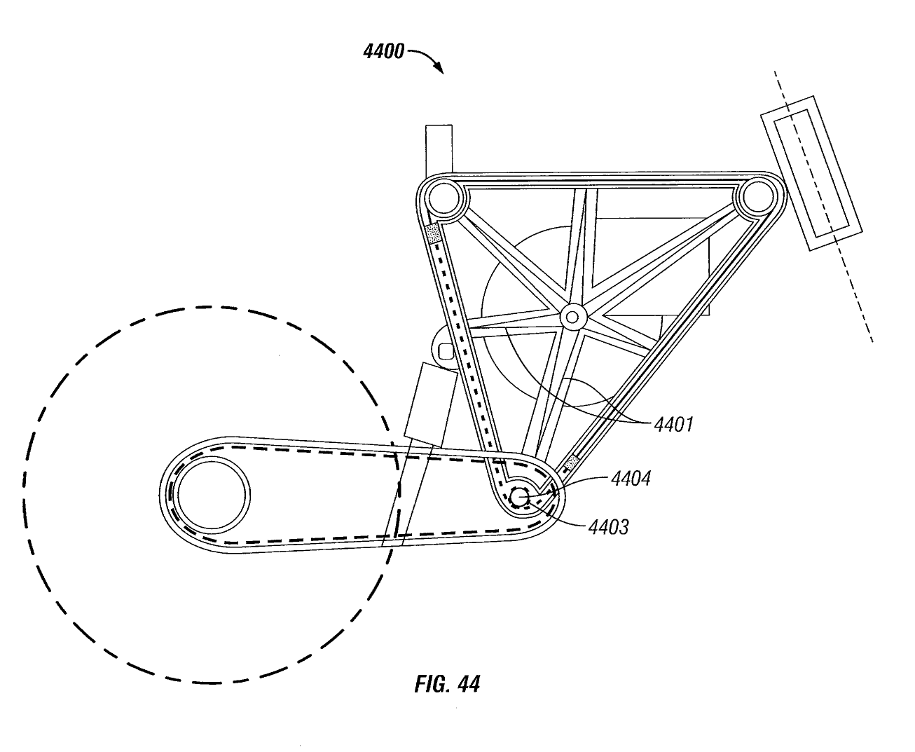

FIG. 43 shows one embodiment of PPA™ 4200 integrated into a bicycle frame. Mechanical means to couple the energy from the gas to the driveline are provided by a continuous cable 4201 fixed to a sliding piston 4202. For propulsion, the piston is pushed by the gas pressure and pulls the cable around its circuit. The cable circuit encircles and turns a pulley block or gear 4203 that is variously connected to the drive-line for propulsion. For regenerative braking and to energize the gas, the pulley or gear is turned by the pedal crank 4204, which moves the cable in the direction to pull the piston against the gas pressure to do work on the gas and thereby store energy in it.

For the alternative fluidic coupling means, the reversible fluidic motor/pump is at the location of the above pulley, thereby to add its torque to the crank-shaft of the drive-line. Fluid that passes through the pump is stored in other frame members, from where it is pumped as required by the energy recovered in regenerative braking or for charging the gas.

The embodiment in FIG. 42 provides the gas storage and cable circuit by doubling one of the main structural tubes the bicycle. FIG. 43 shows an alternative configuration 4300 that uses all three sides of a bicycle frame's structural triangle to store the gas and provide the cable circuit. The gas storage volume is sealed at one end by the attachment of the cable 4301 to the piston 4302 and at the other (flange) end with a sliding seal 4303 that permits motion of the cable. One alternative to the sliding seal at the flange end is a small-diameter extensible bellows that is sealed and fixed to the cable at one end and the flange at the other.

The pneumatic pedal assist uses gearing to translate the force on the piston/tension in the cable to an appropriate level of thrust and deliver the stored energy over a suitable period of time to achieve the desired boost. A 10:1 ratio of the diameters of the pedal crank arm and the PPA™ sprocket is useful for illustration. A gas pressure of 1000 psi (FIG. 43A) at the beginning of the stroke is modest for present-day pneumatic energy storage technology, and will create a force of 1000 lbs on a piston having an area of 1 sq. in. If the radius of the PPA™ sprocket is 1/10 the radius of the pedal crank, equal torques will be provided by the PPA™ and a rider who weighs 100 lbs applying full weight on the pedal. The illustration is for relatively low boost forces. The pressure can be 3000 psi or more and the area can be several square inches. As shown in FIG. 43B, a pressure of 500 psi is present in the gas storage at the end of the stroke.

Gas pressure as needed to store useful amounts of energy is easily contained in tubing of conventional materials and dimensions. However, tension in the belt or chain creates forces that tend to pull the corners of the chain path together, or “buckle” the tube structure. Therefore the structure is designed to resist the buckling failure mode.

For a given piston area, the maximum torque added to the crankshaft by the PPA™ may be set via the maximum gas pressure to make it comparable to the torque provided through the pedal system by the rider. The setting can be higher or lower in line with a spectrum of sporty to utilitarian riders and venues. This maximum torque is adjustable with a supply of pressurized gas provided by a small pump or pressurized canister to change the amount of gas in the PPA™ chamber.

Like an electric drive, PPA™ is conventionally controlled by a handgrip control. But because of its special suitability to provide peak power, the PPA™ boost may be arranged to increase in proportion to force applied to the pedal by the rider.

With the control set as above, PPA™ provides an accelerating torque & thrust whenever activated by pedal pressure. The simplest control is on-or-off. The amount of thrust boost is selected by setting of the pressure of the gas. As a rule-of-thumb, the pressure is selected to give a booster thrust approximately equal to the maximum thrust the rider can provide by pedaling. During the discharge of the pressurized gas, the thrust declines as the gas pressure discharges (FIG. 43B), which depends on the total volume of the gas chamber and the volume swept by the piston.

If the pneumatic pedal assist is used in conjunction with an Electric Pedal Assist EPA™, described herein below, the need for reduction gearing for the electric wheelmotor may be reduced or eliminated.

FIG. 44 shows an electric motor and a battery 4401 in the shape of a toroid mounted in the structural triangle of a bicycle 4400 and connected to the crankshaft in like manner to the PPA™. This configuration of electric motor reduces unsprung weight as compared to a hubmotor configuration. An important objective of suspension design engineers is to reduce unsprung weight to a practical minimum, which includes all the vehicle weight that is not supported by the vehicle's springs, for example wheels, tires and brakes. Alternatively, the electric motor and toroidal battery may be mounted concentric with the pedal's crankshaft. This configuration places the weight lowest, which benefits stability of the bicycle.

The crankshaft 4403 may be driven by a plurality of sprockets 4404, for example one for each of the power sources. A preferred embodiment of the invention is equipped with three sprockets for the three power sources. When not engaged to deliver torque for propulsion, the sprockets each of for the three power sources (pedal/leg muscle; motor/battery; and chain (belt)/pressurized gas) freewheel independently of what the other torque sources are doing. Likewise, when braking, PPA™ and EPA™ can provide regenerative braking independent of each other as well as independent of friction braking applied by the driver.

The main difference in purpose between the PPA™ and EPA™ is that pneumatic is best suited for relatively short bursts of peak power and electric is best for longer duration, which uses the high specific energy density of batteries and minimizes the peak rates of charging and discharging. PPA™ excels at burst power, but is exhausted after accelerating the vehicle to a speed lof approximately 30 mph, or delivering the equivalent energy to a hill climb. In normal operation, the PPA™, EPA™, and pedal sources work in unison, and are controlled according to the driver's goals.

When the PPA™ is not thrusting and the vehicle is being propelled by other means or coasting forward, the PPA™ sprocket is freewheeling. Regenerative braking is engaged by locking the drive-sprocket to over-ride the normal freewheeling, resulting in the chain or belt forcing the piston against the pressurized gas to do work to recover and store the kinetic energy of the vehicle's motion in the pressurized gas. In like manner, rotating the pedals in the opposite direction with the free-wheel sprocket stores energy in the pressurized gas. The threshold force on the pedal for activating the PPA™ can be set as low or as high as desired, within reason.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A vehicle, said vehicle comprising:
at least two substantially identical cells, each cell having two ends and two opposing sides, a bottom surface and a top surface; each cell comprising:
a body section;
at least one pair of wheels, one wheel on each of said opposing sides;
an axle for each wheel, said wheel coupled to said axle,
an independent, swingarm suspension for each wheel, wherein said suspensions couple said axles to said bottom surface of said body section;
a drive motor fixedly attached to said axle, wherein motive force is translated from said drive motor to said wheels;
wherein said cells are assembled end-to-end such that a rigid vehicle body structure is formed;
a steering system, wherein all of said wheels are operative to steer said vehicle, said steering system being microprocessor-controllable;
a power plant for generating power and supplying said power to said drive motors; and
one or more microprocessor control means for centrally controlling at least said steering system;
wherein providing multiple pairs of suspensions closely spaced reduces load requirements for said vehicle structure, so that suspensions for said transit vehicle are manufacturable from lightweight, off-the-shelf parts.

2. A vehicle as in claim 1, said axle comprising one of:
an independent axle for each wheel; and
an end of a continuous axle having two opposing ends, said axle disposed such that said ends are at said opposing sides.

3. A vehicle as in claim 1, further comprising a front unit and an end unit, each of said front unit and said end unit being formed by modifying one of said cells.

4. A vehicle as in claim 1, said vehicle at least partially fabricated from lightweight materials.

5. A vehicle as in claim 1, said steering system comprising:
a steering control interface;
an all-wheel steering assembly; and
a steering actuator attached to each axle, wherein said axles are steerable in unison, or individually steerable.

6. A vehicle as in claim 1, wherein said drive motor comprises one of:
a wheel motor, wherein an outer element rotates with a wheel and an inner element is fixed to an axle; and
a motor mounted to the vehicle inboard of the wheel, wherein power is delivered to the wheel by means of at least one translating members.

7. A vehicle as in claim 1, wherein said drive motor comprises a high-efficiency electric motor.

8. A vehicle as in claim 1, said power plant comprising:
an engine, said engine serving as a basic power source for said vehicle;
a fuel tank;
a generator, wherein power from said engine is converted to electricity, said generator communicating with a drive shaft on said engine;
a generator controller to control capture of electricity and communicating with controllers on individual battery packs to coordinate charging of said battery packs;
an engine cooling system;
a hydraulic unit, said hydraulic unit providing hydraulic power at least, steering and braking systems;
a pneumatic unit, said pneumatic unit providing pneumatic power to at least said suspension;
an engine box; and
a climate control system for passenger areas.

9. A vehicle as in claim 1, further comprising a central control element, said control element operative to control and mediate operation and interaction of vehicle sub-systems and controllers.

10. A wheeled vehicle, said vehicle comprising;
an external frame;
at least one body panel replaceably attached to said frame;
an independent, swingarm suspension coupled to said frame for each wheel.

11. The vehicle of claim 10, wherein said frame is tubular.

12. The vehicle of claim 10, further comprising an axle for each wheel, wherein said suspension couples said axle to said frame.

13. The vehicle of claim 12, further comprising a drive motor fixedly attached to said axle, wherein motive force is translated from said drive motor to said wheel.

14. The vehicle of claim 10, comprising at least a pair of wheels.

15. The vehicle of claim 10, wherein said suspensions are identical.

16. The vehicle of claim 10, wherein said suspensions comprise any of:
at least one trailing link rear suspension;
at least one leading arm front suspension.

17. The vehicle of claim 15, said front suspension further comprising a fork mount, said fork mount having incorporated therein at least one steering bearing.

18. The vehicle of claim 17, further comprising a leading link steering system.

19. The vehicle of claim 15, further comprising an all-wheel steering system.

20. The vehicle of claim 11, wherein said tubular frame comprises a roll cage.

21. The vehicle of claim 10, further comprising a hybrid propulsion system.

22. The vehicle of claim 21, said hybid propulsion system comprising:
a hybrid electric vehicle motor and associated controls, wherein said vehicle motor provides cruise power; and
a battery, wherein said battery provides peak power.

23. The vehicle of claim 22, wherein said battery is chargeable either from an electrical outlet, or from output of said motor.

24. The vehicle of claim 21, further comprising a battery charger, said charger including at least one inverter.

25. The vehicle of claim 21, said hybrid propulsion system comprising a standalone electric generator.

26. The vehicle of claim 25, wherein said generator is portable.

27. The vehicle of claim 22, further comprising a drive train.

28. The vehicle of claim 27, wherein said drive train provides rear-wheel drive;

29. The vehicle of claim 27, said drive train comprising:
a drive axle;
a belt drive between said motor and said drive axle, said belt drive including at least one pulley sized to provide a pretdetermined gear ratio; and
a belt shifter, to switch said belt drive from one pulley to another.
